(19) United States
(12) Patent Application Publication
(10) Pub. No.: US 2026/0292035 A1
(43) Pub. Date: Sep. 24, 2026

(54) SERVICE CONTINUITY FOR EDGE APPLICATION SERVER BUNDLE

(71) Applicant: Telefonaktiebolaget LM Ericsson (publ), Stockholm (SE)

(72) Inventor: Wenliang XU, Shanghai (CN)

(21) Appl. No.: 19/484,615

(22) PCT Filed: May 16, 2024
(86) PCT No.: PCT/IB2024/054774

§ 371 Date: Nov. 14, 2025

(30) Foreign Application Priority Data
May 16, 2023 (WO) PCT/CN2023/094397

(51) Int. Cl. H04L 67/51; H04L 61/4511; H04L 67/148

(52) U.S. Cl. CPC H04L 67/51; H04L 61/4511; H04L 67/148

(57) ABSTRACT

A method implemented in a first network node is described. The method includes determining, based on a service area and/or a data network access identifier (DNAI) of all EASs in bundled EASs that an application context relocation (ACR) is to be performed in a bundle. Each EAS of the bundled EASs has at least one session with an application client (AC) in a user equipment (UE). The method also includes discovering target EASs in the bundle for the bundled EASs, where the target EASs are within a same edge data network (EDN) or different EDNs based on an EAS affinity, and transmitting to an edge enabling server (EES) a declaration message comprising identifier(s) and endpoint(s) of selected target EASs for causing initiation of an application context transfer (ACT) procedure between the EASs in the bundled EASs and the selected target EASs in the bundle.

### TECHNICAL FIELD

The present disclosure relates to wireless communications, and in particular, to providing service continuity for edge application server (EAS) bundle(s).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile user equipment (UE), as well as communication between network nodes and between UEs. The 3GPP is also developing standards for Sixth Generation (6G) wireless communication networks.

EDGEAPP-Architecture for enabling Edge Applications

3GPP Technical Specification (TS) 23.558 V18.2.0 (2023-03) describes the application layer architecture, procedures and information flows for enabling edge applications over 3GPP networks. 3GPP TS 23.558 further describes architectural requirements for enabling edge applications, application layer architecture fulfilling the architecture requirements and procedures to enable the deployment of edge applications.

FIG. 1 shows an example architecture for enabling edge applications, e.g., as shown in 3GPP TS 23.558. Edge data network (EDN) is a local Data Network. Various serves are shown such as edge application server (EAS), edge enabler server (EES), edge configuration server (ECS), notification management server (NMS), etc. A UE is also shown and may comprise one or more of each one of an application client (AC), an edge enabler client (EEC), and a notification management client (NMC). The EES are comprised in the EDN. The ECS provides configurations related to the EES, including details of the EDN hosting the EES. The EAS(s), the EES and the ECS can interact with the 3GPP Core Network. When notification management service is used, the EES and the ECS interact with the notification management server and the EEC interacts with notification management client.

### Service Continuity

Service continuity may include one or more processes such as EEC executed Application Context Relocation (ACR) via source EES (S-EES), source EAS (S-EAS) decided ACR scenario, S-EES executed ACR, e.g., 3GPP TS 23.558 (e.g., clause 8.8).

### EAS Bundle and EAS Composition

3GPP Release 17 (Rel-17) Edge Enabler Layer (EEL) procedures are designed such that services like EAS discovery and service continuity support are performed per EAS, where individual EASs are uniquely identified using EAS endpoints. However, to provide services to the end user, a typical AC communicates with multiple endpoints, i.e., multiple EASs. This creates an EAS bundle, which impacts the support provided by the EEL. Taking an example of an online game where to support large number of users, different game functions are split across multiple servers; like, a game engine for game state and user input management, in-game chat server for communication between players and a capture server for capturing rendered images, encoding, and transporting them to the player's device. If each of these EASs are discovered, controlled, and relocated individually, it may impact the overall quality of service. For example, ACR failing for the game engine should cancel the ACR of the capture server to maintain their proximity. This key issue is to study the impacts on the EEL's support functions created by such EAS bundles or dependencies between the EASs. This KI does not focus on enabling communication between the EASs, rather, it focuses on coordination at the EEL. Open issues may include: How can the EEL identify EAS bundles? What are the impacts on EEL procedures due to EAS bundles, e.g., when the bundled EASs are served by the same EES and require ACR due to UE mobility?

Further, in order for EAS to provide services (weather, transportation, maps, etc.) in partnership with other EASs, EAS context processing and composite EAS support may be required at edge-compatible layers. When ACR occurs due to UE mobility, a method of rearranging the composite EAS context may be required to provide continuous service of the composite EASs. In addition, there may be a need for a method for finding an EAS that provides services to composite EASs within the EDN in which the UE has moved.

Although EAS can discover and communicate other EAS application programming interfaces (APIs) through Common Application Programming Interface Framework (CAPIF) functions, but for service continuity, it may be necessary to discover EASs providing composite EASs and relocation the context of EASs that provided composite capabilities. This key issue (KI) focuses on coordination at the EEL when the composite EASs provide services to the AC on a UE. Open issues include:
Whether and how the EEL can support to composite EAS context management.
Whether and how the EEL can support the relocation of the composite EAS context for service continuity.
Whether and how the EEL can discover EAS that provides the services of the composite EASs

In addition, a liaison exchange (i.e., 3GPP meeting, S6-230509) with 3GPP SA4 group provides additional details about the related EAS. For bundled EAS case (EAS composition can be seen as a special case in bundled EAS where the AC is only aware of its connecting EAS), considering user experience in application use, it is desirable to co-deploy the related EASs (e.g., if EAS 1 communicates with EAS 2, the latency between them can be significantly reduced with co-deployment and co-migration). It may be possible to rename “bundled EAS” to “associated EAS” or “related EAS”, all in all, the spirit of the term is to have relationship among all EASs providing services to AC.

FIG. 2 shows various use cases of edge application architecture. Although valid, Case 1 does not necessarily require co-deployment or co-migration of the two EAS instances because of the lack of any mutual dependency between them. Even if the EAS instances have similar scaling requirements to each other, there is no obvious affinity between them, and therefore no apparent need for them to run on the same host. However, there may be application-specific state maintained in the UE between its invocation of EASx and EASY that makes co-deployment and co-migration desirable in order to achieve a comparable scaling characteristic for the two EAS instances. In addition, while it may be acceptable that the two EAS instances execute on different hosts, there may be a requirement for them to run in the same Edge Data Network because they exchange configuration information about each other (e.g., local IP addresses) with the UE.

Case 2 illustrates a more tightly coupled scenario between EAS instances. If the interaction between them is time-sensitive or data-intensive, there is strong affinity between the two EAS instances and therefore a good reason to co-deploy and co-migrate them. If the interaction is neither time-sensitive nor data-intensive, the affinity is weak, and the EAS instances may just as well run on different hosts. Case 3 is similar to Case 2, and the conclusion is identical. Whether the UE interacts with both EAS instances or just one of them may be immaterial to the question of affinity.

### SUMMARY

Some embodiments advantageously provide methods, systems, and apparatuses for service continuity for EAS bundle. Conventional systems do not provide a solution to address service continuity for bundled EAS ACR. For example, some conventional solutions are not optimized for bundled EAS (e.g., multiple EESs need to perform T-EAS discovery) and do not cover the case where EASs in a bundle are in different EDNs serving the AC.

One or more embodiments provide one or more of the following:
Efficient service continuity (e.g., ACR) with only one entity performing target EAS (T-EAS) discovery which may include:
   Determination of the single entity (i.e. main EAS/EES) in the network side executed ACR scenarios (e.g., two options);
   Enablement of the main source EAS (S-EAS) or main source EES (S-EES) to know the service area and Data Network Access Identifiers (DNAIs) of the associated S-EASs so it can make ACR decision based on detected information (e.g. UE location change, DNAI change).
   Optimization of signaling with associated T-EASs selection.
In the network side (i.e. S-EAS or S-EES) executed ACR scenarios, conveying the EDN connection information to the EEC is supported, e.g., so that the EEC can know what DNN and S-NSSAI are to be used to establish PDU session for application traffic towards the target EDN.

According to one aspect, a network node is described. The network node is configured to and/or includes a radio interface and/or processing circuitry configured to determine a single entity associated with an application context relocation (ACR) process. The single entity is an edge application server (EAS) and is provided with information about a service area and Data Network Access Identifier (DNAI) of at least one associated EAS. The information is usable to make an ACR decision based on detected information.

According to another aspect, a method implemented in a network node is described. The method includes determining a single entity associated with an application context relocation (ACR) process. The single entity is an edge application server (EAS) and provided with information about a service area and Data Network Access Identifier (DNAI) of at least one associated EAS, the information being usable to make an ACR decision based on detected information.

According to one aspect, a user equipment (UE) is described. The UE is configured to and/or includes an edge enabler client (ECC), a radio interface and/or processing circuitry configured to determine a first single entity associated with an application context relocation (ACR) process. The first single entity is an edge application server (EAS) and is provided with information about a first service area and a first Data Network Access Identifier (DNAI) of at least one associated EAS. The information being usable to make a first ACR decision based on first detected information.

In some embodiments, the EEC is configured to determine a second single entity, where the second single entity is an edge enabler server (EES) and is provided with information about a second service area and a second DNAI of at least one associated EAS. The information is usable to make a second ACR decision based on second detected information.

According to another aspect, a method implemented in a user equipment (UE) is described. The UE includes an edge enabler client (ECC). The method includes determining a first single entity associated with an application context relocation (ACR) process. The first single entity is an edge application server (EAS) and is provided with information about a first service area and a first Data Network Access Identifier (DNAI) of at least one associated EAS. The information is usable to make a first ACR decision based on first detected information.

In some embodiments, the method further includes determining, by the ECC, a second single entity. The second single entity is an edge enabler server (EES) and is provided with information about a second service area and a second DNAI of at least one associated EAS. The information is usable to make a second ACR decision based on second detected information.

According to an aspect, a network node configured to communicate with a user equipment (UE) is described. The UE (22) includes an edge enabler client (EEC). The network node is configured to, and/or includes a radio interface (62) and/or processing circuitry (68) configured to determine and transmit, to the EEC edge data network (EDN), connection information associated with an application context relocation (ACR) process. The EDN connection information includes information usable by the EEC to determine what data network name (DNN) and source network slice selection assistance information (S-NSSAI) are to be used to establish a protocol data unit (PDU) session for application traffic towards a target EDN.

According to another aspect, a method implemented in a network node configured to communicate with a user equipment (UE) is described. The UE includes an edge enabler client (EEC). The method includes determining and transmitting to the EEC edge data network (EDN) connection information associated with an application context relocation (ACR) process. The EDN connection information includes information usable by the EEC to determine what data network name (DNN) and source network slice selection assistance information (S-NSSAI) are to be used to establish a protocol data unit (PDU) session for application traffic towards a target EDN.

According to one aspect, a method implemented in a first network node that includes a first edge application server (EAS) is described. The method includes determining, based on one or both of a service area and a data network access identifier (DNAI) of all EASs in bundled EASs that an application context relocation (ACR) is to be performed in a bundle for the bundled EASs. Each EAS of the bundled EASs has at least one session with an application client (AC) in a user equipment (UE). The method also includes discovering target EASs in the bundle for the bundled EASs, where the target EASs are within a same edge data network (EDN) or different EDNs based on an EAS affinity, and transmitting to an edge enabling server (EES) a declaration message comprising one or more identifiers and endpoints of selected target EASs in the bundle for causing initiation of an application context transfer (ACT) procedure between the EASs in the bundled EASs and the selected target EASs in the bundle.

In some embodiments, the method further includes determining the one or both of the service area and the DNAI of all EASs in the bundled EASs based on one or more parameters.

In some other embodiments, at least two target EASs are within the same EDN when the EAS affinity exceeds or is equal to a predetermined EAS affinity threshold, and the at least two target EASs are within different EDNs when the EAS affinity is less than the predetermined EAS affinity threshold.

In some embodiments, the declaration message triggers the EES to send selected target EASs to an edge enabler client (EEC) of the UE.

In some other embodiments, one or both of: A) the method further includes transmitting a declaration request to the EES, where the declaration request includes one or more of a bundle identifier (ID), a list of EAS IDs, and EAS endpoint list; and (B) the declaration request is comprised in the declaration message.

In some embodiments, the EAS is a main EAS, and the EES is a main EES.

According to another aspect, a first network node that includes a first edge application server (EAS) is described. The first network node is configured to determine, based on one or both of a service area and a data network access identifier (DNAI) of all EASs in bundled EASs that an application context relocation (ACR) is to be performed in a bundle for the bundled EASs. Each EAS of the bundled EASs has at least one session with an application client (AC) in a user equipment (UE). The first network node is also configured to discover target EASs in the bundle for the bundled EASs, where the target EASs are within a same edge data network (EDN) or different EDNs based on an EAS affinity, and transmit to an edge enabling server (EES) a declaration message comprising one or more identifiers and endpoints of selected target EASs in the bundle for causing initiation of an application context transfer (ACT) procedure between the EASs in the bundled EASs and the selected target EASs in the bundle.

In some embodiments, the first network node is further configured to determine the one or both of the service area and the DNAI of all EASs in the bundled EASs based on one or more parameters.

In some other embodiments, at least two target EASs are within the same EDN when the EAS affinity exceeds or is equal to a predetermined EAS affinity threshold, and the at least two target EASs are within different EDNs when the EAS affinity is less than the predetermined EAS affinity threshold.

In some embodiments, the declaration message triggers the EES to send selected target EASs to an edge enabler client (EEC) of the UE.

In some other embodiments, one or both of: A) the first network node is further configured to (A) transmit a declaration request to the EES, where the declaration request includes one or more of a bundle identifier (ID), a list of EAS IDs, and EAS endpoint list; and (B) the declaration request is comprised in the declaration message.

In some embodiments, the EAS is a main EAS, and the EES is a main EES.

According to one aspect, a method implemented in a user equipment (UE) is described. The UE includes an edge enabler client (ECC), and the method includes determining that an application context relocation (ACR) is to be performed in a bundle for bundled edge application servers (EASs), where each EAS of the bundled EASs has at least one session with an application client (AC) in the UE. The method also includes discovering target EASs in the bundle for the bundled EASs, where the target EASs are within same edge data network (EDN) or different EDNs based on an EAS affinity, and transmitting to an edge enabling server (EES) an ACR request comprising at least one of one or more identifiers and endpoints of selected target EASs in the bundle.

In some embodiments, the ACR request comprises endpoint information of at least one target EAS of a previous ACR.

In some other embodiments, the endpoint information comprises one or more of a unified resource identifier (URI), a fully qualified domain name (FQDN), and an internet protocol (IP) 3-tuple.

In some embodiments, the ACR request further includes endpoint information of at least one target EAS of a previous ACR when the EEC resends the ACR request to indicate the previous ACR is to be cancelled.

In some other embodiments, the ACR request further includes a list of associated EAS endpoints in the bundle.

In some embodiments, the method further includes subscribing to receive ACR information notifications for target information notification events and ACR complete events from EESs serving the bundle.

According to another aspect, a user equipment (UE) that includes an edge enabler client (ECC) is described. The UE is configured to determine that an application context relocation (ACR) is to be performed in a bundle for bundled edge application servers (EASs), where each EAS of the bundled EASs has at least one session with an application client (AC) in the UE. The UE is further configured to discover target EASs in the bundle for the bundled EASs, where the target EASs are within same edge data network (EDN) or different EDNs based on an EAS affinity, and transmit to an edge enabling server (EES) an ACR request comprising at least one of one or more identifiers and endpoints of selected target EASs in the bundle.

In some embodiments, the ACR request comprises endpoint information of at least one target EAS of a previous ACR.

In some other embodiments, the endpoint information comprises one or more of a unified resource identifier (URI), a fully qualified domain name (FQDN), and an internet protocol (IP) 3-tuple.

In some embodiments, the ACR request further includes endpoint information of at least one target EAS of a previous ACR when the EEC resends the ACR request to indicate the previous ACR is to be cancelled.

In some other embodiments, the ACR request further includes a list of associated EAS endpoints in the bundle.

In some embodiments, the UE is further configured to subscribe to receive ACR information notifications for target information notification events and ACR complete events from EESs serving the bundle.

According to one aspect, a method implemented in a second network node that includes an edge enabling server (EES) is described. The method includes determining, based on one or both of a service area and a data network access identifier (DNAI) of all edge application servers (EASs) in bundled EASs that an application context relocation (ACR) is to be performed in a bundle for the bundled EASs. Each EAS of the bundled EASs has at least one session with an application client (AC) in a user equipment (UE).

The method also includes discovering target EASs in the bundle for the bundled EASs, where the target EASs are within same edge data network (EDN) or different EDNs based on an EAS affinity. The method may also include one of: (A) transmitting to an edge enabling client (EEC) in the UE a notification message that includes one or more identifiers and endpoints of selected target EASs in the bundle and initiating, and triggering initiation of an application context transfer (ACT) procedure between the EASs in the bundled EASs and the selected target EASs in the bundle; and (B) transmitting to the EEC in the UE and to a source EAS (S-EAS) behaving as a main S-EAS for the bundled EASs the one or more identifiers and endpoints of the selected target EASs in the bundle and initiating, and triggering initiation of the ACT procedure between the EASs in the bundled EASs and the selected target EASs in the bundle.

In some embodiments, the method further includes transmitting to at least one of the EAS in the bundled EAS at least one of the identifiers and endpoints of the selected target EASs.

In some other embodiments, the method further includes triggering application traffic influence for the selected target EASs.

In some embodiments, the method further includes notifying a main S-EAS of the selected target EASs of the same EAS service.

In some other embodiments, the method further includes performing an ACR launching procedure including an ACR action indicating ACR initiation and corresponding ACR initiation data to associated EESs.

In some embodiments, the ACR action triggers the associated EESs to notify corresponding bundled source EAS, where the ACT starts between the source EAS and the target EASs in the bundle requiring service continuity.

According to another aspect, a second network node that includes an edge enabling server (EES) is described. The second network node is configured to determine, based on one or both of a service area and a data network access identifier (DNAI) of all edge application servers (EASs) in bundled EASs that an application context relocation (ACR) is to be performed in a bundle for the bundled EASs. Each EAS of the bundled EASs has at least one session with an application client (AC) in a user equipment (UE). The second network node is further configured to discover target EASs in the bundle for the bundled EASs, where the target EASs are within same edge data network (EDN) or different EDNs based on an EAS affinity. The second network node is further configured to one of: (A) transmit to an edge enabling client (EEC) in the UE a notification message that includes one or more identifiers and endpoints of selected target EASs in the bundle and initiate, and trigger initiation of an application context transfer (ACT) procedure between the EASs in the bundled EASs and the selected target EASs in the bundle; and (B) transmit to the EEC in the UE and to a source EAS (S-EAS) behaving as a main S-EAS for the bundled EASs the one or more identifiers and endpoints of the selected target EASs in the bundle and initiate, and trigger initiation of the ACT procedure between the EASs in the bundled EASs and the selected target EASs in the bundle.

In some embodiments, the second network node is further configured to transmit to at least one of the EAS in the bundled EAS at least one of the identifiers and endpoints of the selected target EASs.

In some other embodiments, the second network node is further configured to trigger application traffic influence for the selected target EASs.

In some embodiments, the second network node is further configured to notify a main S-EAS of the selected target EASs of the same EAS service.

In some other embodiments, the second network node is further configured to perform an ACR launching procedure including an ACR action indicating ACR initiation and corresponding ACR initiation data to associated EESs.

In some embodiments, the ACR action triggers the associated EESs to notify corresponding bundled source EAS, where the ACT starts between the source EAS and the target EASs in the bundle requiring service continuity.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example architecture for enabling edge applications;

FIG. 2 shows various use cases of edge application architecture;

FIG. 3 is a schematic diagram of an example network architecture illustrating a communication system connected via an intermediate network to a host computer according to the principles in the present disclosure;

FIG. 4 is a block diagram of a host computer communicating via a network node with a UE over an at least partially wireless connection according to some embodiments of the present disclosure;

FIG. 5 is a flowchart illustrating example methods implemented in a communication system including a host computer, a network node and a UE for executing a client application at a UE according to some embodiments of the present disclosure;

FIG. 6 is a flowchart illustrating example methods implemented in a communication system including a host computer, a network node and a UE for receiving user data at a UE according to some embodiments of the present disclosure;

FIG. 7 is a flowchart illustrating example methods implemented in a communication system including a host computer, a network node and a UE for receiving user data from the UE at a host computer according to some embodiments of the present disclosure;

FIG. 8 is a flowchart illustrating example methods implemented in a communication system including a host computer, a network node and a UE for receiving user data at a host computer according to some embodiments of the present disclosure;

FIG. 9 is a flowchart of an example process in a network node according to some embodiments of the present disclosure;

FIG. 10 is a flowchart of an example process in a UE according to some embodiments of the present disclosure;

FIG. 11 is a flowchart of another example process in a network node according to some embodiments of the present disclosure;

FIG. 12 is a flowchart of an example process in a network node according to some embodiments of the present disclosure;

FIG. 13 is a flowchart of an example process in a UE according to some embodiments of the present disclosure;

FIG. 14 is a flowchart of another example process in a network node according to some embodiments of the present disclosure;

FIG. 15 shows an example S-EAS executed ACR for EAS bundle according to some embodiments of the present disclosure;

FIG. 16 shows another example S-EAS executed ACR for EAS bundle according to some embodiments of the present disclosure;

FIG. 17 shows another example S-EES executed ACR for EAS bundle according to some embodiments of the present disclosure;

FIG. 18 shows an example S-EES executed ACR for EAS bundle according to some embodiments of the present disclosure;

FIG. 19 shows an example ACR launching procedure by the EEC or the SEAS or the S-EES according to some embodiments of the present disclosure; and

FIG. 20 shows an example EAS of information provisioning according to some embodiments of the present disclosure.

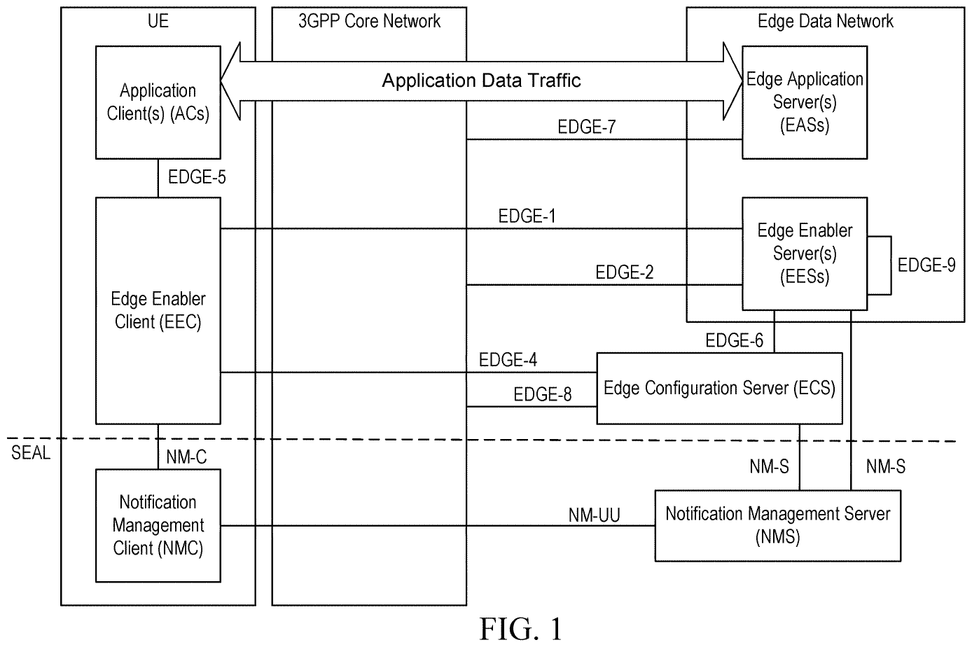

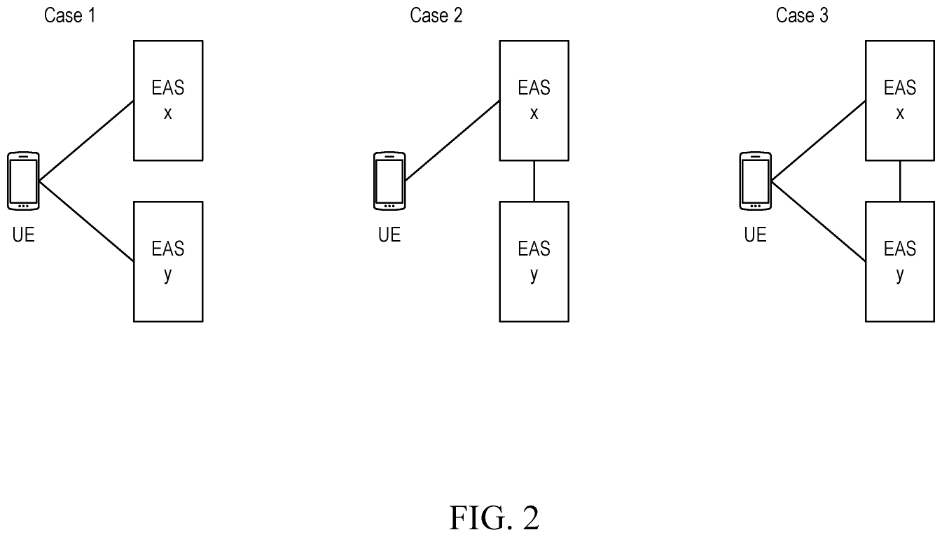

### DETAILED DESCRIPTION

Before describing in detail example embodiments, it is noted that the embodiments reside primarily in combinations of apparatus components and processing steps related to service continuity for EAS bundle. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), EAS, EES, notification management server, etc. The network node may also comprise test equipment. The term “radio node” used herein may be used to also denote a UE such as a UE or a radio network node.

In some embodiments, the non-limiting terms a user equipment (UE) and wireless device (WD) are used interchangeably. The UE herein can be any type of user equipment or wireless device capable of communicating with a network node or another UE over radio signals, such as a UE. The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc. Further, UE may comprise and/or be an AC, EEC, notification management client, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

In some embodiments, various terms are used and may be defined (or refer to) in a nonlimiting fashion as follows.

Application Context: A set of data about the Application Client (AC) that resides in the Edge Application Server (EAS).

Application Context Relocation (ACR): Refers to the end-to-end service continuity procedure.

Application Context Transfer: Refers to the transfer of the Application Context between the source Edge Application Server (EAS) and the target Edge Application Server (EAS), which may be a part of the service continuity procedure.

Application Server: Application software resident in the cloud performing the server function.

Edge Computing: A concept, e.g., as described in 3GPP TS 23.501 V18.1.0 (April 2023), hereinafter referred to as “3GPP TS 23.501”, that enables operator and 3rd party services to be hosted close to the UE's access point of attachment, e.g., to achieve an efficient service delivery through the reduced end-to-end latency and load on the transport network.

Edge Computing Service Provider: A mobile network operator or a 3rd party service provider offering Edge Computing service.

Edge Data Network (EDN): A local Data Network that supports the architecture for enabling edge applications.

EEC Context: A set of data about the Edge Enabler Client (EEC) that resides in the Edge Enabler Server (EES).

Edge Enabler Layer: Refers to the overall functionality provided by the entities such as Edge Enabler Client (EEC), Edge Enabler Server (EES) and Edge Configuration Server (ECS), e.g., in support of applications as per one or more architectures.

Edge Hosting Environment: An environment providing support required for Edge Application Server's execution.

Instantiable EAS: EAS type for which the instantiation trigger from the Edge Enabler Layer is considered by the EAS management system for instantiating EAS.

Main EAS: An EAS in EAS bundle taking the role of controlling the ACR for EAS bundle in network side decided ACR scenario.

Partner ECS: Refers to an ECS deployed by a partner ECSP.

Partner ECSP: An ECSP with whom there is a service level agreement for resource sharing for roaming or federation or both.

In some embodiments, the term bundle is used and may refer to one or more components/elements or a plurality of components/elements. Components/elements may be endpoints or elements of a network, network node, or UE. In some other embodiments, a bundle includes one or more EASs that are group with a predetermined objective.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

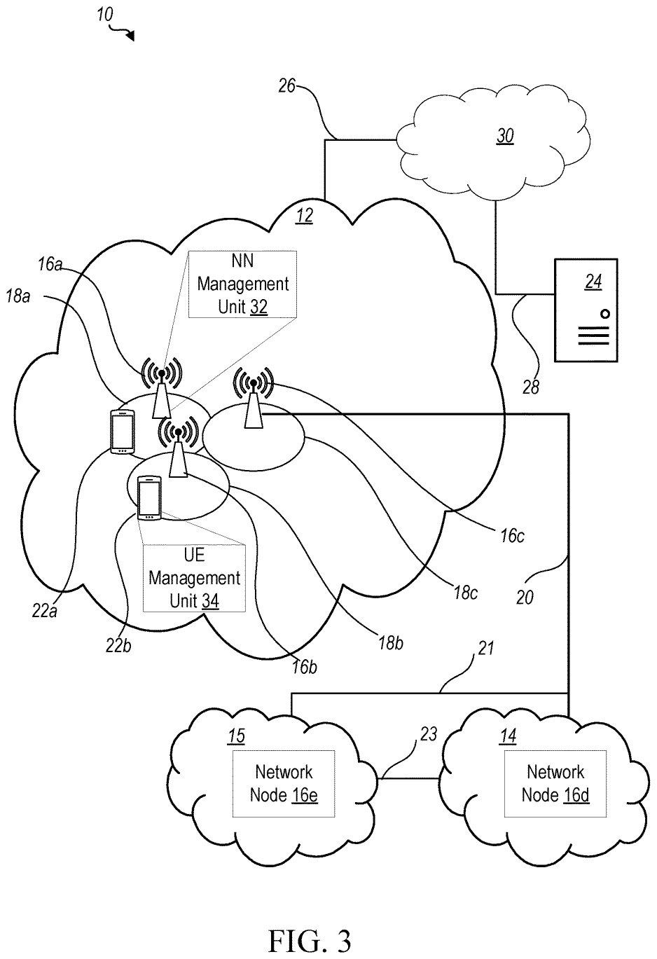

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 (and any other network nodes 16 such as network node 14d) over a wired or wireless connection 20 and/or connectable to an edge data network (EDN) 15 (and any other network nodes 16 such as network node 14e) over a wired or wireless connection 21. Core network 14 may be connectable to EDN 15 via wired or wireless connection 23. A first UE 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 can be in simultaneous communication and/or configured to separately communicate with more than one network node 16 and more than one type of network node 16. For example, a UE 22 can have dual connectivity with a network node 16 that supports LTE and the same or a different network node 16 that supports NR. As an example, UE 22 can be in communication with an eNB for LTE/E-UTRAN and a gNB for NR/NG-RAN. Further, although some connections are shown, any UE 22 and/or any network node 16 may be connectable to and/or comprised in any network such access network 12, core network 14, EDN 15, intermediate network 30, etc.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a NN management unit 32 which is configured to perform any step and/or task and/or process and/or method and/or feature described in the present disclosure, e.g., NN functions. A UE 22 is configured to include a UE management unit 34 which is configured to perform any step and/or task and/or process and/or method and/or feature described in the present disclosure, e.g., UE functions.

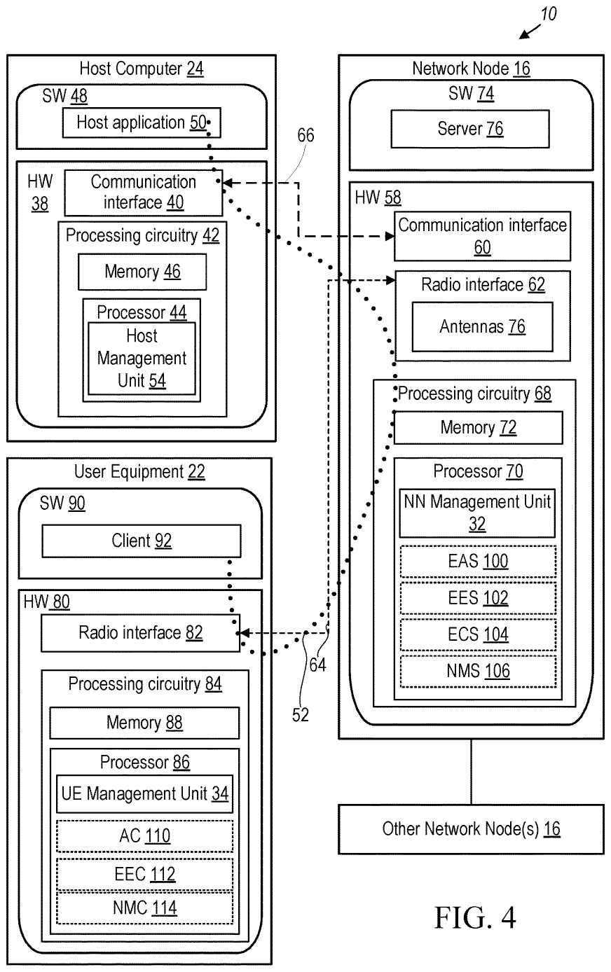

Example implementations, in accordance with an embodiment, of the UE 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the UE 22. The processing circuitry 42 of the host computer 24 may include a host management unit 54 configured to perform any step and/or task and/or process and/or method and/or feature described in the present disclosure, e.g., enable the service provider to observe/monitor/control/transmit to/receive from the network node 16 and or the UE 22.

The communication system 10 further includes a network node 16 provided in a communication system 10 and includes hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. Software 74 may comprise server 76 such as an EAS, an EES, an ECS, a notification management server, etc. However, network node 16 is not limited as such, and server 76 (e.g., EAS, an EES, an ECS, a notification management server, etc.) may be implemented as part of any other component of network node 16 (such as in hardware and/or software) or be standalone. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 which is configured to perform any step and/or task and/or process and/or method and/or feature described in the present disclosure, e.g., NN functions. In one or more embodiments, network node 16 (and/or processing circuitry 68) may include EAS 100, EES 102, ECS 104, and/or NMS 106. EAS 100 may be configured to perform any of the EAS functions described herein. EES 102 may be configured to perform any of the EES functions described herein. ECS 104 may be configured to perform any of the ECS functions described herein. NMS 106 may be configured to perform any of the NMS functions described herein. In some embodiments, NN management unit 32 may comprise a server 76 (e.g., which may perform any of the functions of EAS 100, EES 102, ECCS 104, NMS 106, etc.) and/or perform one or more functions associated with server 76.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client 92 (e.g., application clients, EEC, notification management client, etc.). Client 92 may also refer to a client application. Client 92 may be configured to communicate with EASs, EESs, ECSs, notification manger servers, etc., which may be comprised in a network node 16.

In some embodiments, the client 92 may be operable to provide a service to a human or non-human user via the UE 22, with the support of the host computer 24. In the host computer 24, an executing host application 50 may communicate with the executing client 92 via the OTT connection 52 terminating at the UE 22 and the host computer 24. In providing the service to the user, the client 92 may receive request data from the host application 50 and provide user data in response to the request data. The OTT connection 52 may transfer both the request data and the user data. The client 92 may interact with the user to generate the user data that it provides. Although client 92 is shown as comprised in software 90, client 92 may be comprised in any other component of UE 22 and/or be a combination of software and/or hardware.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client 92 may include instructions that, when executed by the processor 86 and/or processing circuitry 84, causes the processor 86 and/or processing circuitry 84 to perform the processes described herein with respect to UE 22. For example, the processing circuitry 84 of the UE 22 is configured to include a UE management unit 34 which is configured to perform any step and/or task and/or process and/or method and/or feature described in the present disclosure, e.g., UE functions. In one or more embodiments, UE 22 (and/or processing circuitry 84) may include AC 110, EEC 112, ECS 104, and/or NMC 114. AC 110 may be configured to perform any of the AC functions described herein. EEC 112 may be configured to perform any of the EEC functions described herein. NMC 114 may be configured to perform any of the NMC functions described herein. In some embodiments, UE management unit 34 may comprise client 92 (e.g., be configured to perform the functions of AC 110, EEC 112, NMC 114, etc.) and/or perform one or more functions associated with client 92.

In some embodiments, the inner workings of the network node 16, UE 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the UE 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22 and the network node 16 is in accordance with the teachings of the embodiments described throughout this disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing, initiating, maintaining, supporting, ending a transmission to the network node 16, and/or preparing, terminating, maintaining, supporting, ending in receipt of a transmission from the network node 16.

Although FIGS. 3 and 4 show various “units” such as NN management unit 32, and UE management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

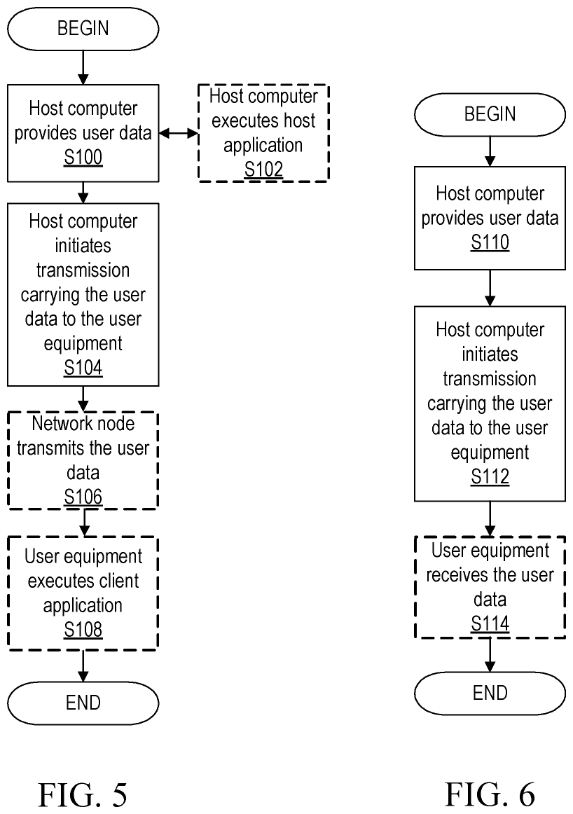

FIG. 5 is a flowchart illustrating an example method implemented in a communication system, such as, for example, the communication system of FIGS. 3 and 4, in accordance with one embodiment. The communication system may include a host computer 24, a network node 16 and a UE 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a UE 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

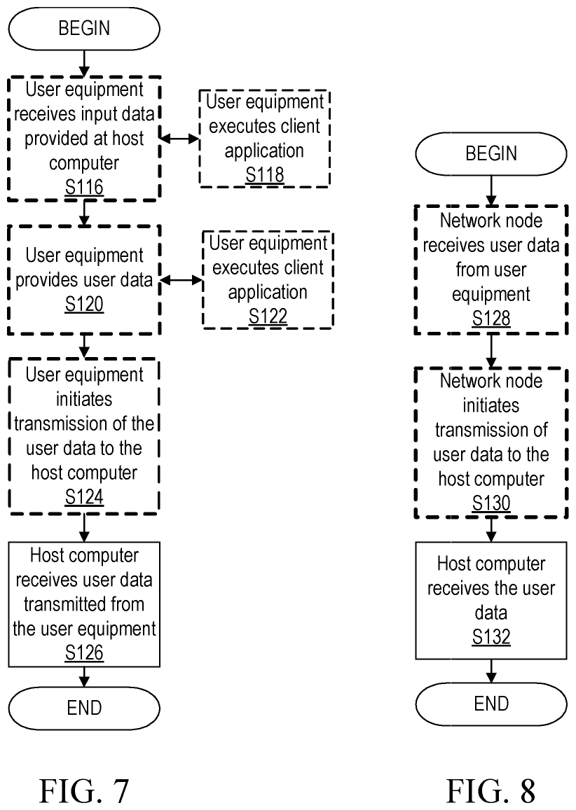

FIG. 7 is a flowchart illustrating an example method implemented in a communication system, such as, for example, the communication system of FIG. 3, in accordance with one embodiment. The communication system may include a host computer 24, a network node 16 and a UE 22, which may be those described with reference to FIGS. 3 and 4. In an optional first step of the method, the UE 22 receives input data provided by the host computer 24 (Block S116). In an optional substep of the first step, the UE 22 executes the client 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client 92 (Block S122). In providing the user data, the executed client 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a UE 22, which may be those described with reference to FIGS. 3 and 4. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

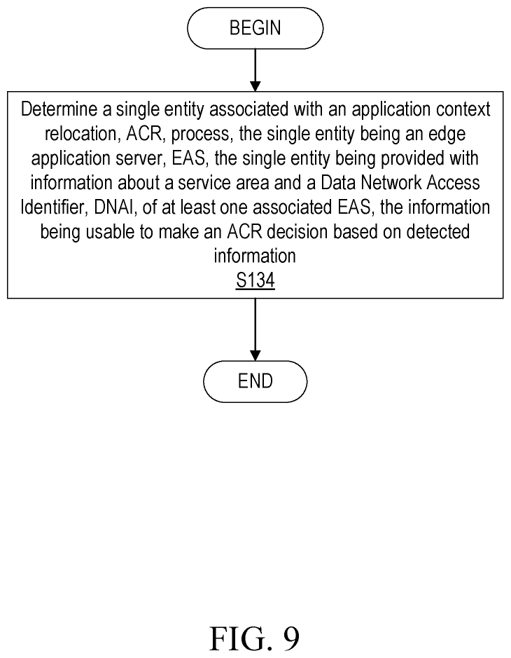

FIG. 9 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S134) a single entity associated with an application context relocation (ACR) process. The single entity is an edge application server (EAS). The single entity is provided with information about a service area and a Data Network Access Identifier (DNAI) of at least one associated EAS. The information is usable to make an ACR decision based on detected information.

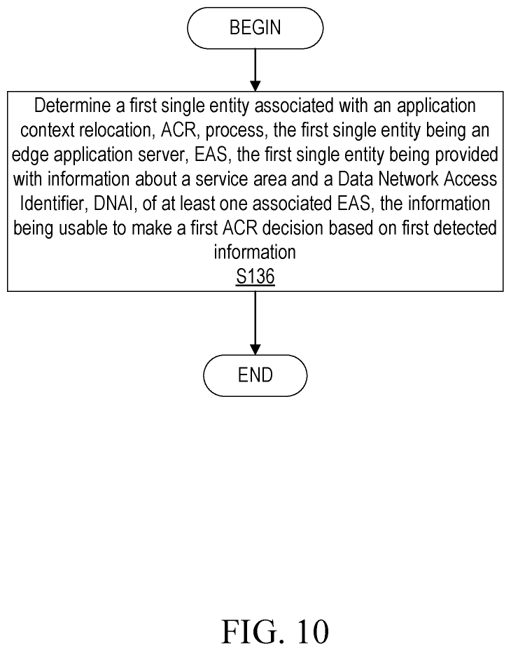

FIG. 10 is a flowchart of an example process in a UE 22 according to some embodiments of the present disclosure. One or more blocks described herein may be performed by one or more elements of UE 22 such as by one or more of an edge enabler client (ECC) and/or processing circuitry 84 (including the UE management unit 34), processor 86, radio interface 82 and/or communication interface 60. UE 22 such as via processing circuitry 84 and/or processor 86 and/or radio interface 82 is configured to determine (Block S136) a first single entity associated with an application context relocation (ACR) process, the first single entity being an edge application server (EAS). The first single entity is provided with information about a service area and Data Network Access Identifier (DNAI) of at least one associated EAS. The information is usable to make a first ACR decision based on first detected information.

In some embodiments, the method further comprises determining, by the ECC, a second single entity. The second single entity is an edge enabler server (EES) and is provided with information about a second service area and a second DNAI of at least one associated EAS. The information is usable to make a second ACR decision based on second detected information.

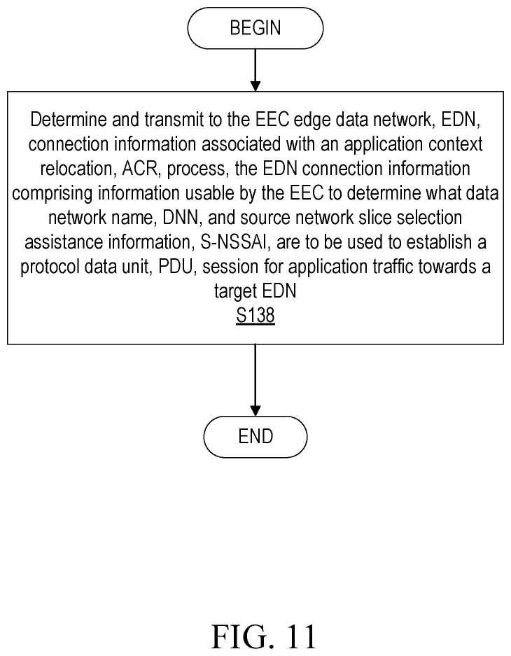

FIG. 11 is a flowchart of an example process in a network node 16 according to some embodiments of the present disclosure. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine and transmit (Block S138) to the EEC edge data network (EDN) (comprised in a corresponding UE 22) connection information associated with an application context relocation (ACR) process. The EDN connection information includes information usable by the EEC to determine what data network name (DNN) and source network slice selection assistance information (S-NSSAI) are to be used to establish a protocol data unit (PDU) session for application traffic towards a target EDN.

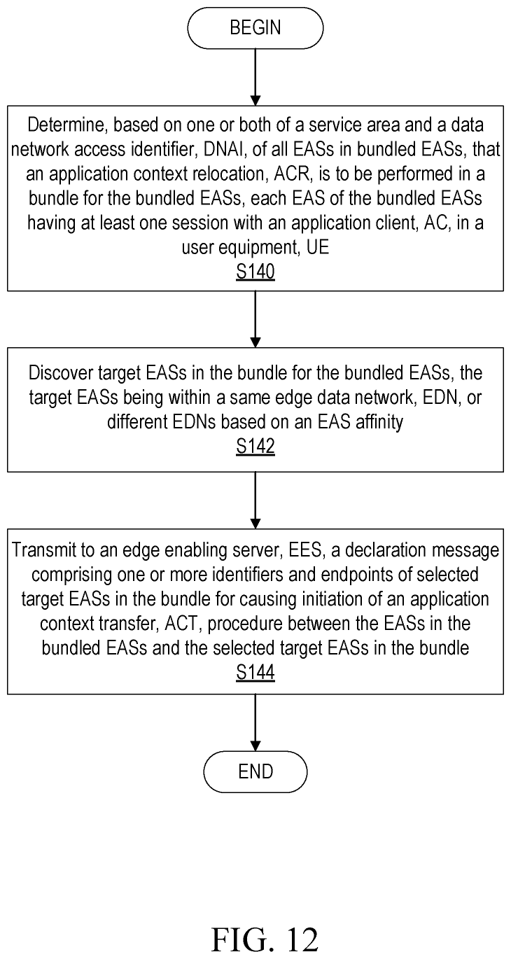

FIG. 12 is a flowchart of an example process in a first network node 16 (e.g., comprising an EAS 100). One or more blocks described herein may be performed by one or more elements of network node 16 such as by one or more of processing circuitry 68 (including the NN management unit 32), processor 70, radio interface 62, communication interface 60, and/or EAS 100. The first network node 16 such as via processing circuitry 68 and/or processor 70 and/or radio interface 62 and/or communication interface 60 is configured to determine (Block S140), based on one or both of a service area and a data network access identifier (DNAI) of all EASs 100 in bundled EASs 100 that an application context relocation (ACR) is to be performed in a bundle for the bundled EASs 100. Each EAS 100 of the bundled EASs 100 has at least one session with an application client (AC) 110 in a user equipment (UE) 22. The first network node 16 is also configured to discover (Block S142) target EASs 100 in the bundle for the bundled EASs 100, where the target EASs 100 are within a same edge data network (EDN) 15 or different EDNs 15 based on an EAS affinity, and transmit (Block S144) to an edge enabling server (EES) 102 a declaration message comprising one or more identifiers and endpoints of selected target EASs 100 in the bundle for causing initiation of an application context transfer (ACT) procedure between the EASs 100 in the bundled EASs 100 and the selected target EASs 100 in the bundle.

In some embodiments, the method further includes determining the one or both of the service area and the DNAI of all EASs 100 in the bundled EASs 100 based on one or more parameters.

In some other embodiments, at least two target EASs 100 are within the same EDN 15 when the EAS affinity exceeds or is equal to a predetermined EAS affinity threshold, and the at least two target EASs 100 are within different EDNs 15 when the EAS affinity is less than the predetermined EAS affinity threshold.

In some embodiments, the declaration message triggers the EES 102 to send selected target EASs 102 to an edge enabler client (EEC) 112 of the UE 22.

In some other embodiments, one or both of: A) the method further includes transmitting a declaration request to the EES 102, where the declaration request includes one or more of a bundle identifier (ID), a list of EAS IDs, and EAS endpoint list; and (B) the declaration request is comprised in the declaration message.

In some embodiments, the EAS 100 is a main EAS 100, and the EES 102 is a main EES 102.

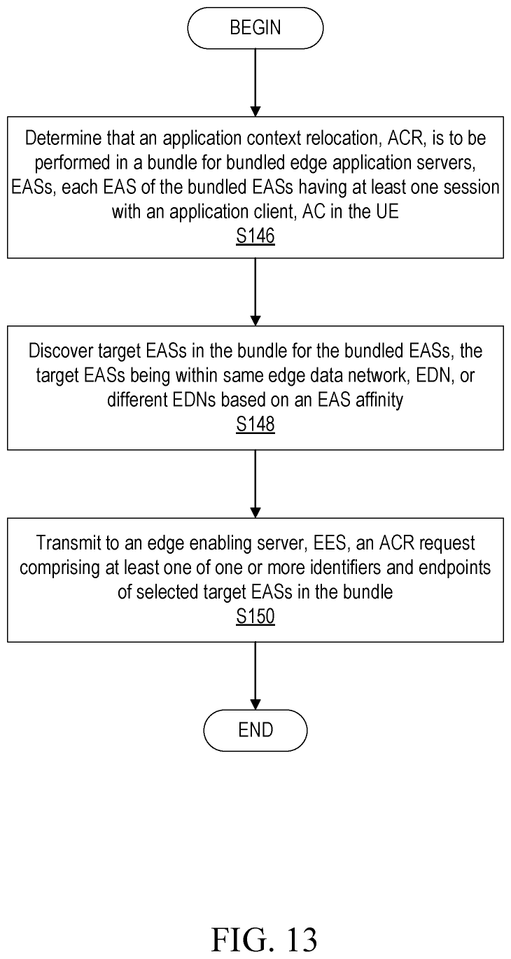

FIG. 13 is a flowchart of an example process in a UE 22 (e.g., comprising an ECC 112). according to some embodiments of the present disclosure. One or more blocks described herein may be performed by one or more elements of UE 22 such as by one or more of an edge enabler client (ECC) 112 and/or processing circuitry 84 (including the UE management unit 34), processor 86, radio interface 82 and/or communication interface 60. UE 22 such as via processing circuitry 84 and/or processor 86 and/or radio interface 82 is configured to determine (Block S146) that an application context relocation (ACR) is to be performed in a bundle for bundled edge application servers (EASs) 100, where each EAS 100 of the bundled EASs 100 has at least one session with an application client (AC) 110 in the UE 22. The UE 22 is further configured to discover (Block S148) target EASs 100 in the bundle for the bundled EASs 100, where the target EASs 100 are within same edge data network (EDN) 15 or different EDNs 15 based on an EAS affinity, and transmit (Block S150) to an edge enabling server (EES) 102 an ACR request comprising at least one of one or more identifiers and endpoints of selected target EASs 100 in the bundle.

In some embodiments, the ACR request comprises endpoint information of at least one target EAS 100 of a previous ACR.

In some other embodiments, the endpoint information comprises one or more of a unified resource identifier (URI), a fully qualified domain name (FQDN), and an internet protocol (IP) 3-tuple.

In some embodiments, the ACR request further includes endpoint information of at least one target EAS 100 of a previous ACR when the EEC 112 resends the ACR request to indicate the previous ACR is to be cancelled.

In some other embodiments, the ACR request further includes a list of associated EAS endpoints in the bundle.

In some embodiments, the method further includes subscribing to receive ACR information notifications for target information notification events and ACR complete events from EESs 102 serving the bundle.

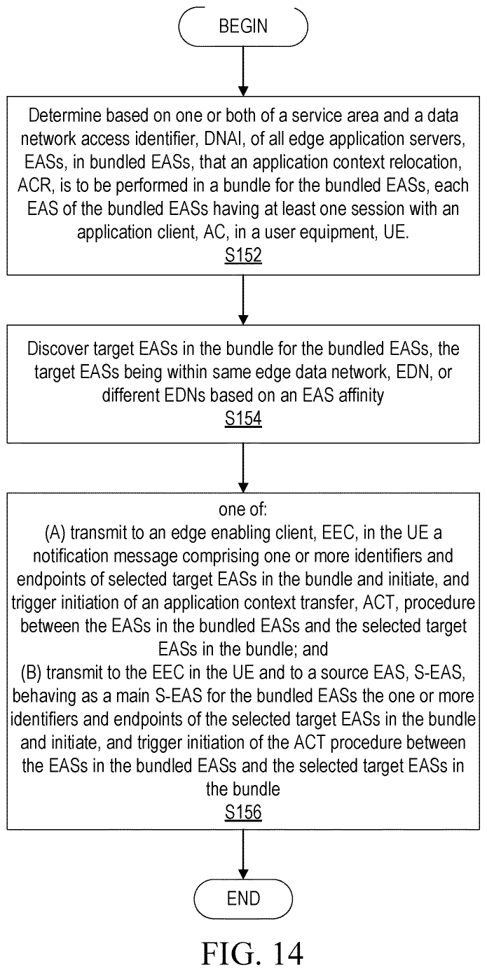

FIG. 14 is a flowchart of an example process in a second network node 16 (e.g., comprising an EES 102). One or more blocks described herein may be performed by one or more elements of network node 16 such as by one or more of processing circuitry 68 (including the NN management unit 32), processor 70, radio interface 62 and/or communication interface 60. The second network node 16 such as via processing circuitry 68 and/or processor 70 and/or radio interface 62 and/or communication interface 60 and EES 102 is configured to determine (Block S152), based on one or both of a service area and a data network access identifier (DNAI) of all edge application servers (EASs) 100 in bundled EASs 100 that an application context relocation (ACR) is to be performed in a bundle for the bundled EASs 100. Each EAS 100 of the bundled EASs 100 has at least one session with an application client (AC) 110 in a user equipment (UE) 22. The second network node 16 is also configured to discover (Block S154) target EASs 100 in the bundle for the bundled EASs 100, where the target EASs 100 are within same edge data network (EDN) 15 or different EDNs 15 based on an EAS affinity. The second network node 16 may also be configured to one of (Block S156): (A) transmit to an edge enabling client (EEC) 112 in the UE 22 a notification message that includes one or more identifiers and endpoints of selected target EASs 100 in the bundle and initiate, and trigger initiation of an application context transfer (ACT) procedure between the EASs 100 in the bundled EASs 100 and the selected target EASs 100 in the bundle; and (B) transmit to the EEC 112 in the UE 22 and to a source EAS (S-EAS) 100 behaving as a main S-EAS 100 for the bundled EASs 100 the one or more identifiers and endpoints of the selected target EASs 100 in the bundle and initiate, and trigger initiation of the ACT procedure between the EASs 100 in the bundled EASs 100 and the selected target EASs 100 in the bundle.

In some embodiments, the method further includes transmitting to at least one of the EAS 100 in the bundled EAS 100 at least one of the identifiers and endpoints of the selected target EASs 100.

In some other embodiments, the method further includes triggering application traffic influence for the selected target EASs 100.

In some embodiments, the method further includes notifying a main S-EAS 100 of the selected target EASs 100 of the same EAS service.

In some other embodiments, the method further includes performing an ACR launching procedure including an ACR action indicating ACR initiation and corresponding ACR initiation data to associated EESs 102.

In some embodiments, the ACR action triggers the associated EESs 102 to notify corresponding bundled source EAS 100, where the ACT starts between the source EAS 100 and the target EASs 100 in the bundle requiring service continuity.

Having described the general process flow of arrangements of the disclosure and having provided examples of hardware and software arrangements for implementing the processes and functions of the disclosure, the sections below provide details and examples of arrangements for service continuity for EAS bundle.

In one or more embodiments, the term UE is used which generally refers to UE 22. Further, each of the terms EAS, EES, ECS, and notification management server (NMS) generally may refer to EAS 100, EES 102, ECS 104, NMS 106, respectively, and/or refer to one or more network nodes 16. Similarly, the terms AC, EEC, and notification management client (NMC) may refer to AC 110, EEC 112, and NMC 114, respectively, and/or to one or more UEs 22. In some embodiments, one or more options (e.g., Option 1, Option 2) are described. In some other embodiments, any of the options or elements of the options may be combined with the options or elements of the other options.

### 8.8.1.x (Option 1) Service Continuity for EAS Bundle

This clause (Service continuity for EAS bundle) describes solution of relocating EASs in a bundle together instead of individual relocation for AC-EAS sessions one by one. To avoid ACR being triggered for each EAS in a bundle with different initiators (e.g. EAS 1 and EAS 2 in a bundle trigger ACR simultaneously), a main EAS may be used and a main EES is used correspondingly. The main EAS or EES is responsible for ACR detection and initiation in the network side. The main EAS information is sent to EEL and the main EES is the EES registering the main EAS.
NOTE 1: An Application Service Provider (ASP) can have a requirement of the dependencies between bundled EAS(s) when provisioning them for any deployment scenario and indicate whether the affinity between them as strong (co-deployment is essential) or weak (co-deployment is only “nice to have”).
NOTE 2: It is possible that some EASs in a bundle do not need relocation because the UE can still be served by these EASs. A deployment example is both EASs providing services covering the whole city and EASs providing services covering city district are serving the AC as an EAS bundle, and when UE moves from one district to another district in the city, only EASs serving the district from where UE is moving out need relocation.
NOTE 3: In the proxy type of bundle, the main EAS is the connecting EAS serving the AC.
NOTE 4: In current release of the specification, the main EAS is selected by ASP.

### 8.8.1.x (Option 2) Service Continuity for EAS Bundle

Associated EASs in a bundle can register in the same EES or different EES(s) in an EDN. It is also possible that the some EASs in a bundle are registered in EES(s) in other EDNs. During UE mobility, the UE may be out of edge coverage of certain EDNs, then EASs serving the AC in the UE in certain EDNs may need to be relocated. Whether to start ACR is determined by decision-making entity (e.g. EEC, S-EES) based on detected information like UE location.
NOTE 1: During deployment, if EAS affinity is set to strong, associated EASs are preferably to be registered in the same EES; otherwise, associated EASs can register in the same EES in an EDN or different EESs in the same EDN or different EDNs.
NOTE 2: It is possible that some EASs in a bundle do not need relocation because the UE can still be served by these EASs. A deployment example is both EASs providing services covering the whole city and EASs providing services covering city district are serving the AC as an EAS bundle, and when UE moves from one district to another district in the city, only EASs serving the district from where UE is moving out need relocation.

ACR scenarios for EAS bundle are described in clause 8.8.2.x1, clause 8.8.2.x2 and clause 8.8.2.x3. The aim is to relocate EASs in a bundle in an efficient way instead of individual relocation for AC-EAS sessions one by one. To avoid ACR being triggered for each EAS in a bundle with different initiators (e.g. EAS 1 and EAS 2 in a bundle trigger ACR simultaneously), a main EAS needs to be determined and a main EES is determined correspondingly. The main EAS or EES is responsible for ACR detection and initiation in the network side. Such a determination may be performed in ACR scenario selection of EAS Information provisioning procedure in clause 8.15. This may be dynamic determination in edge enabler layer (e.g. by EEC or EES). Another option is determination by application over the top (see NOTE 3); therefore, AC profile and EAS profile include information about main EAS. The corresponding impact is depicted in clauses 7.2.10, 8.2.2 and 8.2.4.
NOTE 3: Main EAS decided by AC and EAS specific means is out of scope of this specification.

### 8.8.2.x1 (Option 1) ACR for Direct EAS Bundle, Executed by EEC

In this scenario, the EEC executes necessary ACR for AC-EAS service session(s) in a bundle, and it follows the scenario described in clause 8.8.2.3 with the following differences:
all T-EAS(s) in a bundle requiring service continuity are discovered and selected during step 3. If the affinity is set to strong, then T-EASs are from the same EDN.
NOTE: T-EAS(s) should be within the same EDN as preferred if EAS affinity is preferred, or different EDNs if no T-EAS(s) in same EDN available, if the EAS affinity is set to weak.
all bundled T-EAS endpoints are sent to the corresponding S-EES(s) in the ACR request and the S-EES(s) may apply AF traffic influence for the received T-EAS(s) in step 4a.
Each associated EES (i.e. EES serving bundle EASs) aggregates ACR status update from its served and bundled EASs in step 7 and step 8 and sends ACR complete notification to the EEC in step 9.
The EEC collects ACR complete notifications in step 9 and completes the ACR for the EAS bundle.

### 8.8.2.x1 (Option 2) ACR for EAS Bundle, Executed by EEC

In this scenario, the EEC executes necessary ACR for AC-EAS service session(s) in a bundle, it follows the scenario described in clause 8.8.2.3 with differences that:
all T-EAS(s) in a bundle requiring service continuity are discovered and selected during step 3. If the EAS affinity is set to strong (i.e. bundle ID is provided), the EEC selects the T-EAS(s) served by the same T-EES; otherwise, the EEC prefers to select the T-EAS(s) served by the same T-EES.

NOTE: The EEC can select the T-EAS(s) within the same EDN or different EDNs if the EAS affinity is set to weak.
all associated T-EAS endpoints are sent to the corresponding S-EES(s) in ACR request and the S-EES(s) may apply AF traffic influence for the received T-EES(s) in step 4a.
The EES(s) aggregates ACR status update from its served and associated EASs in step 7 and step 8 and sends ACR complete notification to the EEC in step 9.
The EEC collects ACR complete notifications in step 9 and completes the ACR for the EAS bundle.

### 8.8.2.x2 (Option 1) ACR for EAS Bundle, Executed by S-EAS

In this scenario, the main S-EAS executes and triggers necessary ACR for all AC-EAS service session(s) in a bundle.

This scenario description is same as described for FIG. 8.8.2.4-1 except for the following clarifications:

### Pre-Condition:

1. The main S-EAS may depend on the receipt of ACR management events from its S-EES, e.g. “user plane path change” events or “ACR monitoring” events as described in clause 8.6.3, to detect the need for an ACR. The main S-EAS may also depend on the receipt of UE location notification from its S-EES as described in clause 8.6.2.2.3, to detect the need for an ACR. For the following procedure it is assumed that the main S-EAS has subscribed to continuously receive the respective events; and
2. The EEC has subscribed to receive ACR information notifications for target information notification events and ACR complete events from S-EESs serving the EAS bundle, as described in clause 8.8.3.5.2.

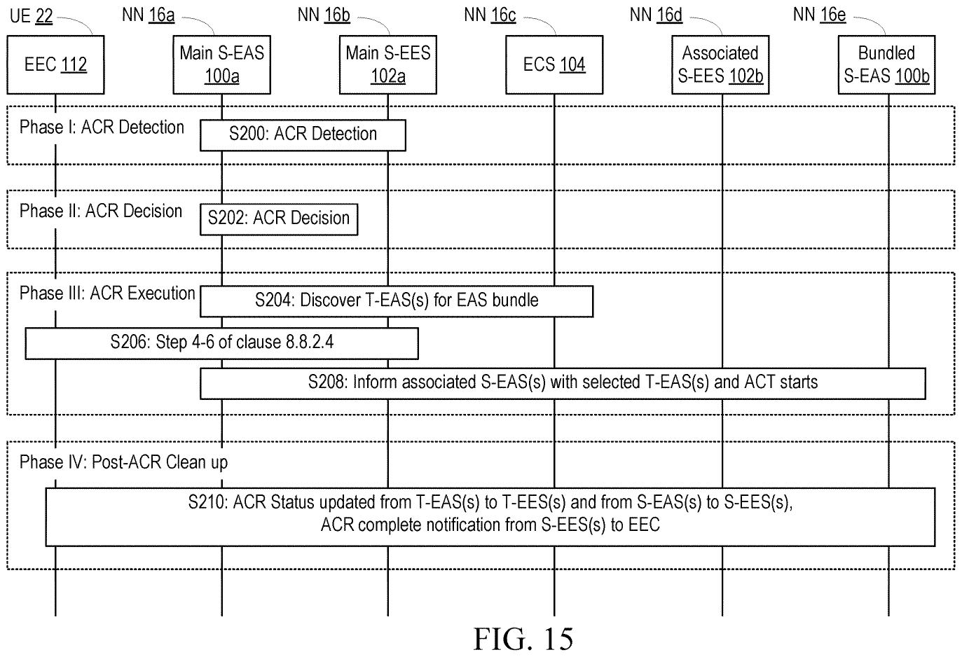

FIG. 15 shows an example S-EAS executed ACR for EAS bundle. A UE 22 comprising an EEC 112, a network node (NN) 16a (e.g., main S-EAS 100a), NN 16b (e.g., main S-EES 102a), NN 16c (e.g., ECS 104), NN 16d (e.g., associated S-EES 102b), and NN 16e (e.g., bundled S-EAS 100b) are shown.

### Phase I: ACR Detection

S200. ACR is detected, the procedure is same as step 1 of clause 8.8.2.4.

### Phase II: ACR Decision

S202. The main S-EAS performs ACR decision for bundled EASs.
NOTE 1: The main S-EAS is aware of all bundle EASs service area and/or DNAIs so it can decide whether to perform ACR for the corresponding EASs.

### Phase III: ACR Execution

S204. The main S-EAS discovers from all candidate T-EAS(s) in EAS bundle. If the affinity is set to strong, then T-EASs are from the same EDN. The main S-EAS may apply AF traffic influence for all bundled T-EAS(s).

NOTE: T-EAS(s) should be within the same EDN as preferred if EAS affinity is preferred, or different EDNs if no T-EAS(s) in same EDN available, if the EAS affinity is set to weak.
S206. The procedure is same as step 4 to step 6 of clause 8.8.2.4. The main S-EAS sends selected T-EAS declaration message to the main S-EES with the selected T-EASs, the main S-EES sends selected T-EAS(s) to the EEC.
S208. The main S-EES informs associated S-EESs with bundled T-EASs. Then ACT starts between the S-EAS(s) and T-EAS(s) in a bundle requiring service continuity.

### Phase IV: Post-ACR Clean Up

S210. During post-ACR, all S-EASs and T-EASs send ACR status update to S-EES and T-EES, respectively, as described in step 8 and step 9 of clause 8.8.2.4. The EEC collects ACR complete notifications from all S-EESs and ACR for EAS bundle is completed.
Steps S200, S202, S204, S206, S208, and S210 may be referred to as steps 1, 2, 3, 4, 5, and 6, respectively.

### 8.8.2.x2 (Option 2) ACR for EAS Bundle, Executed by S-EAS

In this scenario, a main S-EAS executes and triggers necessary ACR for AC-EAS service session(s) in a bundle.

This scenario description is same as described for FIG. 8.8.2.4-1 except for the following clarifications:

### Pre-Condition:

1. The main S-EAS may depend on the receipt ACR management events from the main S-EES, e.g. “user plane path change” events or “ACR monitoring” events as described in clause 8.6.3, to detect the need for an ACR. The main S-EAS may also depend on the receipt of UE location notification from the main S-EES as described in clause 8.6.2.2.3, to detect the need for an ACR. For the following procedure it is assumed that the main S-EAS has subscribed to continuously receive the respective events from the main S-EES; and
2. The EEC has subscribed to receive ACR information notifications for target information notification events and ACR complete events from S-EESs serving the EAS bundle, as described in clause 8.8.3.5.2

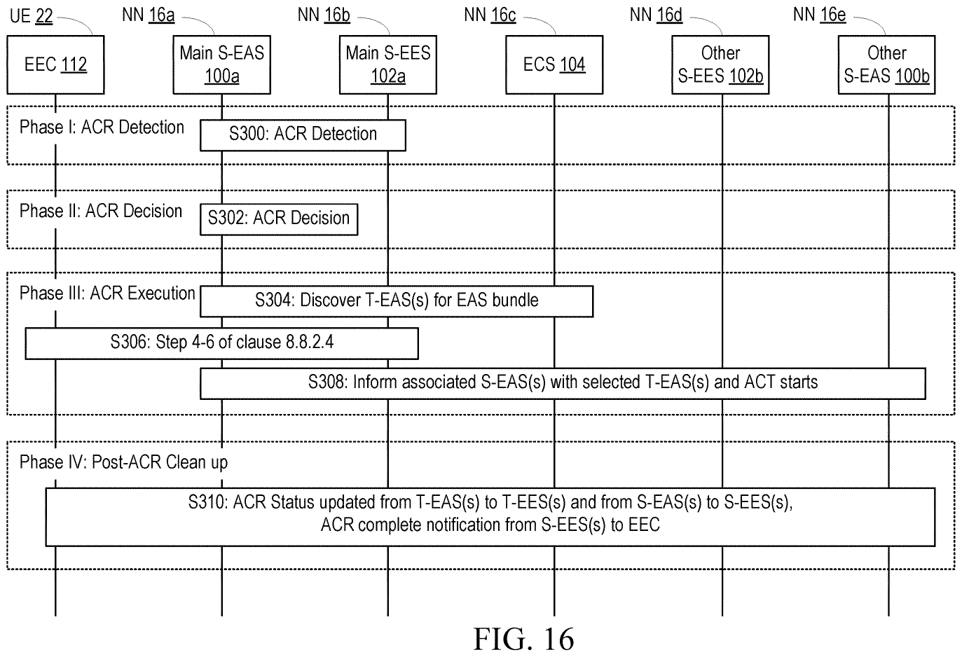

FIG. 16 shows another example S-EAS executed ACR for EAS bundle. A UE 22 comprising an EEC 112, a network node (NN) 16a (e.g., main S-EAS 100a), NN 16b (e.g., main S-EES 102a), NN 16c (e.g., ECS 104), NN 16d (e.g., other S-EES 102b), and NN 16e (e.g., other S-EAS 100b) are shown.

### Phase I: ACR Detection

S300. ACR is detected, the procedure is same as step 1 of clause 8.8.2.4.

### Phase II: ACR Decision

S302. The main S-EAS performs ACR decision for bundled EASs.

NOTE 1: The main S-EES is aware of all associated EASs service area and/or DNAIs so it can decide whether to perform ACR for the corresponding EASs.

### Phase III: ACR Execution

S304. The main S-EAS discovers from all candidate T-EAS(s) in EAS bundle. If the EAS affinity is set to strong (i.e. bundle ID is provided), the main S-EAS selects the T-EAS(s) served by the same T-EES; otherwise, the main S-EAS prefers to select the T-EAS(s) served by the same T-EES. The main S-EAS may apply AF traffic influence for all associated T-EAS(s).
NOTE 2: The main S-EAS can select the T-EAS(s) within the same EDN or different EDNs if the EAS affinity is set to weak.
S306. The procedure is the same as step 4 to step 6 of clause 8.8.2.4. The main S-EAS sends selected T-EAS declaration message to the main S-EES with the selected T-EASs, the main S-EES sends selected T-EAS(s) to the EEC.
S308. The main S-EES informs associated S-EASs with associated T-EASs in the same EDN and ACT starts between the associated S-EAS(s) and T-EAS(s) in a bundle requiring service continuity, which are outside the scope of this specification.

### Phase IV: Post-ACR Clean Up

S310. During post-ACR, all S-EASs and T-EASs send ACR status update to S-EES and T-EES, respectively, as described in step 8 and step 9 of clause 8.8.2.4. The EEC collects ACR complete notifications from all S-EESs and ACR for EAS bundle is completed.

Steps S300, S302, S304, S306, S308, and S310 may be referred to as steps 1, 2, 3, 4, 5, and 6, respectively.

### 8.8.2.x3 (Option 1) ACR for EAS Bundle, Executed by S-EES

In this scenario, a main S-EES (serving a main S-EAS) executes and triggers necessary ACR for AC-EAS service session(s) in a bundle.

This scenario description is same as described for FIG. 8.8.2.5-1 except for the following clarifications:

### Pre-Condition:

1. The AC at the UE already has a connection with S-EASs in a bundle;
2. The EEC subscribes to receive ACR information notifications for target information notification events and ACR complete events from S-EESs serving the EAS bundle, as described in clause 8.8.3.5.2;
3. The main S-EAS may subscribe to receive ACR management notifications for “ACR facilitation” events to the main S-EES, in order to enable ACR detection at the main S-EES.

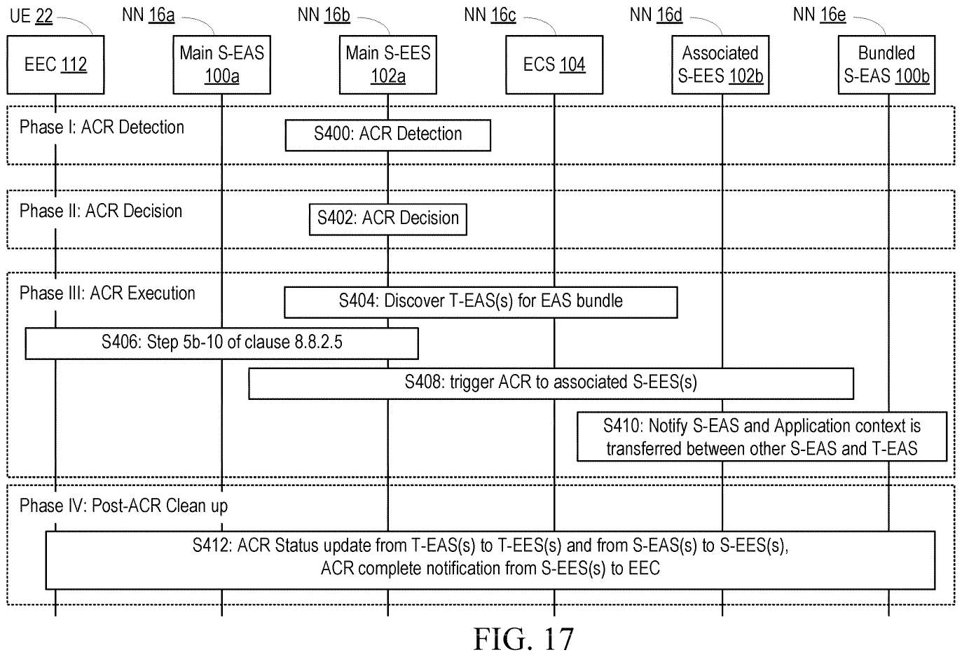

FIG. 17 shows an example S-EES executed ACR for EAS bundle. A UE 22 comprising an EEC 112, a network node (NN) 16a (e.g., main S-EAS 100a), NN 16b (e.g., main S-EES 102a), NN 16c (e.g., ECS 104), NN 16d (e.g., associated S-EES 102b), and NN 16e (e.g., bundled S-EAS 100b) are shown.

### Phase I: ACR Detection

S400. The main S-EES detects the need for ACR, the procedure is same as step 2 of clause 8.8.2.5.

### Phase II: ACR Decision

S402. The main S-EES performs ACR decision for bundled EASs.
NOTE 1: The main S-EES is aware of all bundle EASs service area and/or DNAIs so it can decide whether to perform ACR for the corresponding EASs.

### Phase III: ACR Execution

S404. The main S-EES discovers all candidate T-EAS(s) in EAS bundle. If the affinity is set to strong, then T-EASs are from the same EDN.

NOTE: T-EAS(s) should be within the same EDN as preferred if EAS affinity is preferred, or different EDNs if no T-EAS(s) in same EDN available, if the EAS affinity is set to weak.
S406. The procedure is same as step 5b to step 10 of clause 8.8.2.5. The main S-EES sends selected T-EAS(s) to the EEC, triggers application traffic influence for T-EAS(s) and notifies the main S-EAS with selected T-EAS of the same EAS service. The main S-EES may notify more S-EAS(s) with selected T-EAS of the corresponding EAS service.
S408. The main S-EES performs ACR launching procedure (as described in clause 8.8.3.4) with the ACR action indicating ACR initiation and the corresponding ACR initiation data to the associated S-EES(s).
S410. The associated S-EES(s) notifies the corresponding bundled S-EAS(s) and ACT starts between the S-EAS(s) and T-EAS(s) in a bundle requiring service continuity.

### Phase IV: Post-ACR Clean up

S412. During post-ACR, all S-EASs and T-EASs send ACR status update to S-EES and T-EES, respectively, as described in step 12 and step 13 of clause 8.8.2.5. The EEC collects ACR complete notifications from all S-EESs and ACR for EAS bundle is completed.

Steps S400, S402, S404, S406, S408, S410, and S412 may be referred to as steps 1, 2, 3, 4, 5, 6, and 7 respectively.

### 8.8.2.x3 (Option 2) ACR for EAS Bundle, Executed by S-EES

In this scenario, a main S-EES (serving a main S-EAS) executes and triggers necessary ACR for AC-EAS service session(s) in a bundle.

This scenario description is same as described for FIG. 8.8.2.5-1 except for the following clarifications:

### Pre-Condition:

1. The AC at the UE already has a connection with S-EASs in a bundle;
2. The EEC subscribes to receive ACR information notifications for target information notification events and ACR complete events from S-EESs serving the EAS bundle, as described in clause 8.8.3.5.2;
3. The main S-EAS may subscribe to receive ACR management notifications for “ACR facilitation” events to the main S-EES, in order to enable ACR detection at the main S-EES.

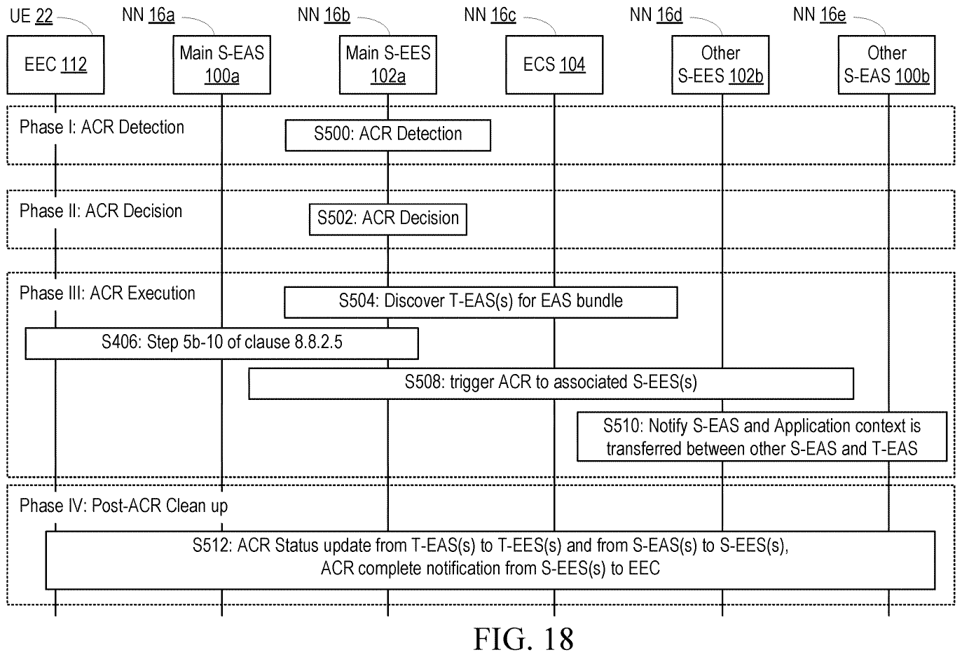

FIG. 18 shows an example S-EES executed ACR for EAS bundle. A UE 22 comprising an EEC 112, a network node (NN) 16a (e.g., main S-EAS 100a), NN 16b (e.g., main S-EES 102a), NN 16c (e.g., ECS 104), NN 16d (e.g., other S-EES 102b), and NN 16e (e.g., other S-EAS 100b) are shown.

### Phase I: ACR Detection

S500. The main S-EES detects the need for ACR, the procedure is same as step 2 of clause 8.8.2.5.

### Phase II: ACR Decision

S502. The main S-EES performs ACR decision for bundled EASs.
NOTE 1: The main S-EES is aware of all associated EASs service area and/or DNAIs so it can decide whether to perform ACR for the corresponding EASs.

### Phase III: ACR Execution

S504. The main S-EES discovers from all candidate T-EAS(s) in EAS bundle. If the EAS affinity is set to strong (i.e. bundle ID is provided), the S-EES selects the T-EAS(s) served by the same T-EES; otherwise, the main S-EES prefers to select the T-EAS(s) served by the same T-EES.
NOTE 2: The main S-EES can select the T-EAS(s) within the same EDN or different EDNs if the EAS affinity is set to weak.
S506. The procedure is same as step 5b to step 10 of clause 8.8.2.5. The main S-EES sends selected T-EAS(s) to the EEC, triggers application traffic influence for T-EAS(s) and notifies the main S-EAS with selected T-EAS of the same EAS service. The main S-EES may notify more S-EAS(s) with selected T-EAS of the corresponding EAS service.
S508. The main S-EES performs ACR launching procedure (as described in clause 8.8.3.4) with the ACR action indicating ACR initiation and the corresponding ACR initiation data to the associated S-EES(s).
S510. The associated S-EES(s) notifies the corresponding associated S-EAS(s) and ACT starts between the associated S-EAS(s) and T-EAS(s).

### Phase IV: Post-ACR Clean Up

S512. During post-ACR, all S-EASs and T-EASs send ACR status update to S-EES and T-EES, respectively, as described in step 12 and step 13 of clause 8.8.2.5. The EEC collects ACR complete notifications from all S-EESs and ACR for EAS bundle is completed.

Steps S500, S502, S504, S506, S508, S510, and S512 may be referred to as steps 1, 2, 3, 4, 5, 6, and 7 respectively.

### 8.8.3.4 ACR Launching Procedure

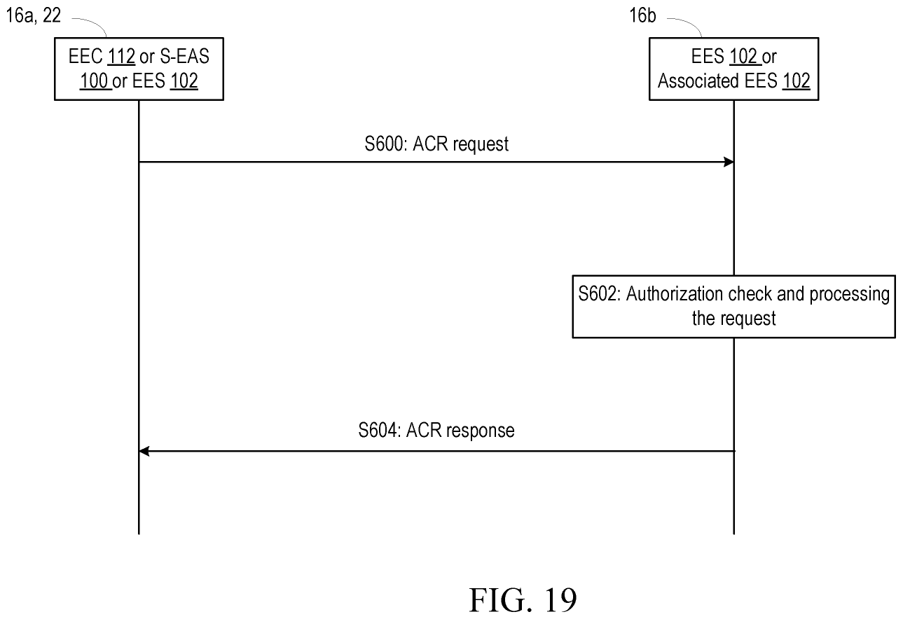

FIG. 19 illustrates the ACR launching procedure by the EEC 112 or the S-EAS 100 or the S-EES 102. A UE 22 comprising an EEC 112 and/or a network node (NN) 16a (e.g., comprising an S-EAS 100 or EES 102), NN 16b (e.g., comprising an EES 102 or associated EES 102) are shown.

If this procedure is triggered by the EEC, depending on the ACR action indicated in the ACR request, the procedure is used for ACR initiation, ACR determination or ACR modification which is described in clause 8.8.1.4. The procedure of the ACR initiation can be re-sent as described in clause 8.8.1.3 to cancel an ACR.

If this procedure is triggered by the S-EAS, the procedure is used for ACR determination.

If this procedure is triggered by the S-EES to the associated S-EES(s), this procedure is used for the direct bundle EAS case.

### Pre-Condition:

For EEC as consumer:
1. The EEC has been authorized to communicate with the EES as specified in clause 8.11, if the procedure is triggered by the EEC.

For S-EAS as consumer:
1. Information related to the S-EES is available with the S-EAS.

For EES as consumer:
1. The S-EES obtained the associated S-EES(s) information as specified in clause 8.15.2.2.

The following steps may be performed:
S600. The EEC or the S-EAS sends an ACR request message to the EES in order to start ACR. The ACR request message may include Predicted/Expected UE location or Expected AC Geographical Service Area to indicate that the EES should detect whether the UE has moves to the Predicted/Expected UE location or Expected AC Geographical Service Area or not in ACR clean-up phase. The ACR request message includes ACR action to indicate either ACR initiation request or ACR determination request. If the procedure is triggered by the S-EAS, the ACR request message is only for ACR determination.

An ACR request for ACR initiation sent by the EEC:
includes an indication of whether the EEC requests the EES to perform EAS notification; and
provides information used by EES to perform AF traffic influence as in 3GPP TS 23 501. The EEC sent ACR request for ACR initiation may include the simultaneous EAS connectivity information in service continuity (see table 8.8.4.4-1) if previously received as part of the AC profile.

An ACR request for ACR determination sent either by the EEC or the EAS informs the EES that the need for ACR has been detected by the requestor.

An ACR request for ACR modification sent by the EEC:
includes IDs to identify the ACR that is requested to be modified; and
includes the ACR parameters to be modified.

An ACR request for direct bundle EAS case sent by the S-EES:
includes direct bundle T-EAS(s) received in step 4 in 8.8.3.2 related to the associated S-EES(s) based on the EASID, which EASID of the associated S-EES is corresponding to the direct bundle T-EAS(s) profile.
S602. The EES checks if the requestor is authorized for this operation. If authorized, the EES processes the request and performs the required operations.

If the request in step 1 is for ACR initiation:
the EES may use information provided in the request to apply the AF traffic influence with the N6 routing information of the T-EAS in the 3GPP Core Network (if applicable), as described in 3GPP TS 23.501, clause 5.6.7.1; and

NOTE: The simultaneous EAS connectivity information sent by EES is used to maintain both S-PSA and T-PSA in supporting simultaneous connectivity with both S-EAS and T-EAS during the service continuity as described in clause 6.3.4 of 3GPP TS 23.548.

Since the 3GPP CN only supports simultaneous PSA connectivity in SSC mode 3 or session breakout, it is FFS whether EES should firstly know PDU session capability before invoking AF traffic influence API.
if the EAS notification indication in ACR initiation data is provided in the step 1 request and the EAS has subscribed to receive such notification, the EES may notify the EAS indicated in the ACR initiation data about the need to start ACR by sending an ACR management notification for the “ACT start” event, as described in clause 8.6.3.

If the request in step 1 is for ACR determination, the EES decides to execute ACR as described in clause 8.8.2.5.

If the request in step 1 includes Previous T-EAS Endpoint:
if the previous EAS notification indication is provided in the step 1 request and the EAS has subscribed to receive such notification, the EES may notify the EAS about the cancellation of the ACR with the previous T-EAS by sending an ACR management notification for the “ACT stop” event, as described in clause 8.6.3.
The EAS will inform the remote EAS about application context cancellation, which is outside the scope of this specification. The T-EAS sends the ACR status update message to the T-EES which will include failed result with an appropriate cause indicating the reason for the failure.

If the request in step 1 is for ACR modification:
the EES identifies the ACR to be modified based on the ID parameters in the request in step 1. If the request in step 1 is to the S-EES, the S-EES performs the ACR parameter information procedure as described in clause 8.8.3.9. If the request in step 1 is to the T-EES, and if the T-EAS has subscribed to receive ACR notifications, the T-EES may notify the T-EAS by sending an ACR management notification, with “ACT start” event including ACR parameters from the request in step 1, e.g. Prediction expiration time.

If the request in step 1 is for direct bundle EAS case, then the associated T-EES may use received direct bundle T-EAS(s) for ACR.
S604. The EES responds to the requestor's request with an ACR response message.

In case of re-sending ACR initiation, if serving EES was changed and EEC context was relocated, the T-EES can clean up any relocated EEC context either indicated in the re-sent ACR request for scenario described in clause 8.8.2.6 or upon reception of the ACR status update with failed result from T-EAS for other scenarios.

Steps S600, S602, and S604 may be referred to as steps 1, 2, and 3, respectively.

### 8.8.4.4 (Option 1) ACR Request

Table 8.8.4.4-1 describes information elements for the ACR request sent either from the EEC to the S-EES or T-EES, or by the S-EAS to the S-EES.

TABLE 8.8.4.4-1
ACR request

| Information element | Status | Description |
|---|---|---|
| Requestor Identifier | M | Unique identifier of the requestor (i.e. |
| | | EECID or EASID). |
| Security credentials | M | Security credentials resulting from a |
| | | successful authorization for the edge |
| | | computing service. |
| EASID | O | Identifier of the EAS |
| EAS bundle information | O | EAS bundle information. |
| >Bundle ID or list of | M | A list of EASIDs or a bundle ID as |
| EASID | | described in clause 7.2.10. |
| UE identifier | M | The identifier of the UE (i.e. GPSI). |
| Predicted/Expected UE | O | The predicted/expected location |
| location or Expected AC | | information of the UE. The UE location is |
| Geographical Service Area | | described in clause 7.3.2 or the |
| (NOTE 8) | | predicted/expected Expected AC |
| | | Geographical Service Area as described in |
| | | clause 7.3.3.3 |
| ACID (NOTE 10) | O | The identifier of the AC. |
| ACR action (NOTE 3) | M | Indicates the ACR action (ACR initiation, |
| | | ACR determination or ACR modification) |
| ACR initiation data (NOTE | O | ACR initiation IEs to be included in an |
| 2) | | ACR request message when ACR action |
| | | indicates it is ACR initiation request. |
| >T-EAS Endpoint | M | Endpoint information (e.g. URI, FQDN, |
| | | IP 3-tuple) of the T-EAS. |
| >Previous T-EAS | O | Endpoint information (e.g. URI, FQDN, |
| Endpoint (NOTE 7) | | IP 3-tuple) of the T-EAS of the previous |
| | | ACR. |
| >DNAI of the T-EAS | O | DNAI information associated with the T- |
| | | EAS. |
| >N6 Traffic Routing | O | The N6 traffic routing information and/or |
| requirements | | routing profile ID corresponding to the T- |
| | | EAS DNAI. |
| >Simultaneous EAS | O | Indicates if simultaneous EAS |
| connectivity information | | connectivity is needed and the inactive |
| | | time guidance for keeping connectivity |
| | | towards the S-EAS. |
| >EAS notification | M | Indicates whether to notify the EAS about |
| indication | | the need of ACR. |
| >Previous EAS | O | Indicates whether to notify the EAS about |
| notification indication | | the cancellation of a previous ACR. |
| (NOTE 7) | | |
| >S-EAS endpoint (NOTE | O | Endpoint information of the S-EAS |
| 1) | | |
| >Bundled T-EAS endpoint | O | A list of associated EAS endpoints in an |
| list | | EAS bundle. |
| >ACR parameters (NOTE | O | Parameters of the ACR |
| 9) | | |
| >>Prediction expiration | O | The estimated time the UE may reach the |
| time | | Predicted/Expected UE location or EAS |
| | | service area at the latest |
| >EEC context relocation | O | Information required for EEC context |
| details | | relocation using the EEC context push or |
| | | EEC context pull mechanisms. |
| >>EEC Context ID | O | Identifier of the EEC Context |
| (NOTE 5) | | |
| >>S-EES ID (NOTE 5) | O | Identifier of the EES that provided EEC |
| | | context ID. |
| >>S-EES endpoint | O | The endpoint address (e.g. URI, IP |
| (NOTE 5) | | address) of the EES that provided EEC |
| | | context ID. |
| >>T-EES ID (NOTE 6) | O | Identifier of the T-EES. |
| >>T-EES endpoint | O | The endpoint address (e.g. URI, IP |
| (NOTE 6) | | address) of the T-EES. |
| ACR determination data | O | ACR determination les to be included in |
| (NOTE 2) | | an ACR request message when ACR |
| | | action indicates it is ACR determination |
| | | request. |
| >S-EAS endpoint | M | Endpoint information of the SEAS |
| ACR modification data | O | ACR modification Ies to be included in an |
| (NOTE 2) | | ACR request message when ACR action |
| | | indicates it is ACR modification request. |
| >S-EAS Endpoint | M | Endpoint information (e.g. URI, FQDN, |
| | | IP 3-tuple) of the S-EAS. |
| >T-EAS Endpoint | M | Endpoint information (e.g. URI, FQDN, |
| | | IP 3-tuple) of the T-EAS. |
| >ACR parameters | M | ACR parameters |
| >>Prediction expiration | O | The estimated time the UE may reach the |
| time | | Predicted/Expected UE location or EAS |
| | | service area at the latest |

(NOTE 1):
This IE may be present if the EAS notification indication or previous EAS notification indication indicates that the EAS needs to be informed.
(NOTE 2):
One of the ACR initiation, ACR determination or ACR modification may be included corresponding to the ACR action.
(NOTE 3):
This IE may indicate ACR determination if the request originates from the SEAS.
(NOTE 4):
Void.
(NOTE 5):
This IE may be present only if the request originates from the EEC towards the T-EES.
(NOTE 6):
This IE may be present only if the request originates from the EEC towards the S-EES.
(NOTE 7):
These IEs may be present when the EEC re-sends the ACR request as described in clause 8.8.1.3 to indicate a previous ACR is to be cancelled.
(NOTE 8):
This IE may be present if the ACR procedure is for service continuity planning.
(NOTE 9):
This IE may be included when the ACR is decided and executed for service continuity planning for a predicted/expected UE location.
(NOTE 10):
The IE may be present when the action is ACR modification to identify the ACR to be modified.

### 8.8.4.4 (Option 2) ACR Request

Table 8.8.4.4-1 describes information elements for the ACR request sent either from the EEC to the S-EES or T-EES, or by the S-EAS to the S-EES.

TABLE 8.8.4.4-1
ACR request

| Information element | Status | Description |
|---|---|---|
| Requestor Identifier | M | Unique identifier of the requestor (i.e., |
| | | EECID or EASID). |
| Security credentials | M | Security credentials resulting from a |
| | | successful authorization for the edge |
| | | computing service. |
| EASID | O | Identifier of the EAS |
| Associated EASIDs | O | Associated EAS Identifiers. |
| UE identifier | M | The identifier of the UE (i.e., GPSI). |
| Predicted/Expected UE | O | The predicted/expected location |
| location or Expected AC | | information of the UE. The UE location is |
| Geographical Service Area | | described in clause 7.3.2 or the |
| (NOTE 8) | | predicted/expected AC Geographical |
| | | Service Area as described in clause |
| | | 7.3.3.3 |
| ACID (NOTE 10) | O | The identifier of the AC. |
| ACR action (NOTE 3) | M | Indicates the ACR action (ACR initiation, |
| | | ACR determination or ACR modification) |
| ACR initiation data (NOTE | O | ACR initiation IEs to be included in an |
| 2) | | ACR request message when ACR action |
| | | indicates it is ACR initiation request. |
| >T-EAS Endpoint | M | Endpoint information (e.g., URI, FQDN, |
| | | IP 3-tuple) of the T-EAS. |
| >Previous T-EAS | O | Endpoint information (e.g., URI, FQDN, |
| Endpoint (NOTE 7) | | IP 3-tuple) of the T-EAS of the previous |
| | | ACR. |
| >DNAI of the T-EAS | O | DNAI information associated with the T- |
| | | EAS. |
| >N6 Traffic Routing | O | The N6 traffic routing information and/or |
| requirements | | routing profile ID corresponding to the T- |
| | | EAS DNAI. |
| >Simultaneous EAS | O | Indicates if simultaneous EAS |
| connectivity information | | connectivity is needed and the inactive |
| | | time guidance for keeping connectivity |
| | | towards the S-EAS. |
| >EAS notification | M | Indicates whether to notify the EAS about |
| indication | | the need of ACR. |
| >Previous EAS | O | Indicates whether to notify the EAS about |
| notification indication | | the cancellation of a previous ACR. |
| (NOTE 7) | | |
| >S-EAS endpoint (NOTE | O | Endpoint information of the S-EAS |
| 1) | | |
| >Associated T-EAS | O | A list of associated EAS endpoints in an |
| endpoint list | | EAS bundle. |
| >ACR parameters (NOTE | O | Parameters of the ACR |
| 9) | | |
| >>Prediction expiration | O | The estimated time the UE may reach the |
| time | | Predicted/Expected UE location or EAS |
| | | service area at the latest |
| >EEC context relocation | O | Information required for EEC context |
| details | | relocation using the EEC context push or |
| | | EEC context pull mechanisms. |
| >>EEC Context ID | O | Identifier of the EEC Context |
| (NOTE 5) | | |
| >>S-EES ID (NOTE 5) | O | Identifier of the EES that provided EEC |
| | | context ID. |
| >>S-EES endpoint | O | The endpoint address (e.g., URI, IP |
| (NOTE 5) | | address) of the EES that provided EEC |
| | | context ID. |
| >>T-EES ID (NOTE 6) | O | Identifier of the T-EES. |
| >>T-EES endpoint | O | The endpoint address (e.g., URI, IP |
| (NOTE 6) | | address) of the T-EES. |
| ACR determination data | O | ACR determination IEs to be included in |
| (NOTE 2) | | an ACR request message when ACR |
| | | action indicates it is ACR determination |
| | | request. |
| >S-EAS endpoint | M | Endpoint information of the S-EAS |
| ACR modification data | O | ACR modification IEs to be included in an |
| (NOTE 2) | | ACR request message when ACR action |
| | | indicates it is ACR modification request. |
| >S-EAS Endpoint | M | Endpoint information (e.g. URI, FQDN, |
| | | IP 3-tuple) of the S-EAS. |
| >T-EAS Endpoint | M | Endpoint information (e.g. URI, FQDN, |
| | | IP 3-tuple) of the T-EAS. |
| >ACR parameters | M | ACR parameters |
| >>Prediction expiration | O | The estimated time the UE may reach the |
| time | | Predicted/Expected UE location or EAS |
| | | service area at the latest |

(NOTE 1):
This IE may be present if the EAS notification indication or previous EAS notification indication indicates that the EAS needs to be informed.
(NOTE 2):
One of the ACR initiation, ACR determination or ACR modification may be included corresponding to the ACR action.
(NOTE 3):
This IE may indicate ACR determination if the request originates from the SEAS.
(NOTE 4):
Void.
(NOTE 5):
This IE may be present only if the request originates from the EEC towards the T-EES.
(NOTE 6):
This IE may be present only if the request originates from the EEC towards the S-EES.
(NOTE 7):
These IEs may be present when the EEC re-sends the ACR request as described in clause 8.8.1.3 to indicate a previous ACR is to be cancelled.
(NOTE 8):
This IE may be present if the ACR procedure is for service continuity planning.
(NOTE 9):
This IE may be included when the ACR is decided and executed for service continuity planning for a predicted/expected UE location.
(NOTE 10):
The IE may be present when the action is ACR modification to identify the ACR to be modified.

### 8.8.4.10 (Option 1) ACR Information Notification

Table 8.8.4.10-1 describes the information elements for ACR information notification from the EES to the EEC.

TABLE 8.8.4.10-1
ACR information notification

| Information | | |
|---|---|---|
| element | Status | Description |
| Subscription ID | M | Subscription identifier |
| | | corresponding to the subscription stored in |
| | | the EES for the request |
| EASID | M | The identifier of the EAS |
| ACID | O | The identifier of the AC |
| | | corresponding to the Selected target EAS |
| Event ID | M | Either Target information |
| | | notification or ACR complete |
| Target information | O | Details of the selected T-EAS and |
| (NOTE 1) | | the T-EES. |
| >T-EAS | M | Details of the selected T-EAS as |
| information | | described in ‘Discovered EAS’ IE of |
| | | Table 8.5.3.3-1. |
| >Bundled T-EAS | O | A list of T-EASs in an EAS |
| information list | | bundle, the T-EASs are selected by the |
| | | network side and details are described in |
| | | ‘Discovered EAS’ IE of Table 8.5.3.3-1. |
| >T-EES | O | Details of the selected T-EES as |
| information (NOTE 4) | | described in ‘EDN configuration |
| | | information’ IE of Table 8.3.3.3.3-1. |
| >EDN connection | O | EDN connection information as |
| information | | described in Table 8.3.3.3.3-2. |
| ACR complete | O | Details of a completed ACR and |
| event information (NOTE | | its result. |
| 2) | | |
| Result of ACR | M | Indicates whether the ACR is |
| (NOTE 2) | | successful or failure |
| >T-EAS endpoint | M | Endpoint address of the T-EAS to |
| | | which an ACR has been performed. |
| >Bundled T-EAS | O | A list of associated EAS endpoints |
| endpoint list | | in an EAS bundle. |
| EEC Context | O | Indicates whether the EEC context |
| Relocation status (NOTE | | relocation was successful or not. |
| 5) | | |
| >Registration Id | O | Identifier of the registration for the |
| (see NOTE 6) | | EEC. |
| >Expiration Time | O | Indicates the expiration time of the |
| (see NOTE 6) | | registration. |
| Cause information | O | Indicates the cause information for |
| (see NOTE 3) | | the failure |
| Selected ACR | O | List of selected ACR scenarios. |
| scenario list (see NOTE 6) | | |

(NOTE 1):
This IE may be included when Event ID indicates ‘Target information notification’ event.
(NOTE 2):
This IE may be included when Event ID indicates ‘ACR complete’ event.
(NOTE 3):
This IE may be included when the Result of ACR indicates failure.
(NOTE 4):
This IE may be included if the selected T-EES is different from the S-EES. Otherwise, it may be skipped.
(NOTE 5):
This IE may be included when Event ID indicates ‘ACR complete’ event and EEC context relocation was attempted.
(NOTE 6):
This IE may be included if S-EES has received it in EEC Context Push response.

### 8.8.4.10 (Option 2) ACR Information Notification

Table 8.8.4.10-1 describes the information elements for ACR information notification from the EES to the EEC.

TABLE 8.8.4.10-1
ACR information notification

| Information | | |
|---|---|---|
| element | Status | Description |
| Subscription ID | M | Subscription identifier |
| | | corresponding to the subscription stored in |
| | | the EES for the request |
| EASID | M | The identifier of the EAS |
| ACID | O | The identifier of the AC |
| | | corresponding to the Selected target EAS |
| Event ID | M | Either Target information |
| | | notification or ACR complete |
| Target information (NOTE | O | Details of the selected T-EAS and |
| 1) | | the T-EES. |
| >T-EAS information | M | Details of the selected T-EAS as |
| | | described in ‘Discovered EAS’ IE of |
| | | Table 8.5.3.3-1. |
| >Associated T-EAS | O | A list of associated T-EASs in an |
| information list | | EAS bundle, the associated T-EASs are |
| | | selected by the network side and details |
| | | are described in ‘Discovered EAS’ IE of |
| | | Table 8.5.3.3-1. |
| >T-EES information | O | Details of the selected T-EES as |
| (NOTE 4) | | described in ‘EDN configuration |
| | | information’ IE of Table 8.3.3.3.3-1. |
| >EDN connection | O | EDN connection information as |
| information | | described in Table 8.3.3.3.3-2. |
| ACR complete event | O | Details of a completed ACR and |
| information (NOTE 2) | | its result. |
| Result of ACR (NOTE 2) | M | Indicates whether the ACR is |
| | | successful or failure |
| >T-EAS endpoint | M | Endpoint address of the T-EAS to |
| | | which an ACR has been performed. |
| >Associated T-EAS | O | A list of associated EAS endpoints |
| endpoint list | | in an EAS bundle. |
| EEC Context Relocation | O | Indicates whether the EEC context |
| status (NOTE 5) | | relocation was successful or not. |
| >Registration Id | O | Identifier of the registration for the |
| (see NOTE 6) | | EEC. |
| >Expiration Time | O | Indicates the expiration time of the |
| (see NOTE 6) | | registration. |
| Cause information | O | Indicates the cause information for |
| (see NOTE 3) | | the failure |
| Selected ACR scenario list | O | List of selected ACR scenarios. |
| (see NOTE 6) | | |

(NOTE 1):
This IE may be included when Event ID indicates ‘Target information notification’ event.
(NOTE 2):
This IE may be included when Event ID indicates ‘ACR complete’ event.
(NOTE 3):
This IE may be included when the Result of ACR indicates failure.
(NOTE 4):
This IE may be included if the selected T-EES is different from the S-EES. Otherwise, it may be skipped.
(NOTE 5):
This IE may be included when Event ID indicates ‘ACR complete’ event and EEC context relocation was attempted.
(NOTE 6):
This IE may be included if S-EES has received it in EEC Context Push response.

The EDN connection information may be a general enhancement applicable for both non-bundled EAS and bundled EAS cases. When EEC receives the EDN connection info, it may use the DNN and network slice information to establish PDU session for application traffic towards the Target EDN.

### 8.8.4.17 (Option 1) Selected Target EAS Declaration Request

Table 8.8.4.17-1 describes information elements for the selected target EAS declaration request (e.g., a declaration message) sent from the S-EAS to the S-EES.

TABLE 8.8.4.17-1
Selected target EAS declaration request

| Information element | Status | Description |
|---|---|---|
| UE ID | M | The identifier of the UE. |
| Security credentials | M | Security credentials. |
| Selected EAS ID | M | Selected EAS identifier. |
| ACID | O | The identifier of the AC |
| Selected EAS Endpoint | M | Endpoint of the selected EAS. |
| EAS bundle information | O | EAS bundle information. |
| >Bundle ID or list of | M | A list of EASIDs or a bundle ID as |
| EASID | | described in clause 7.2.10. |
| >T-EAS endpoint list | M | A list of associated EAS endpoints in an |
| | | EAS bundle, selected by the S-EAS. |
| Predicted/Expected UE | O | The predicted/expected location |
| location or Expected AC | | information of the UE. The UE location is |
| Geographical Service Area | | described in clause 7.3.2 or the |
| | | predicted/expected Expected AC |
| | | Geographical Service Area as described in |
| | | clause 7.3.3.3 |

### 8.8.4.17 (Option 2) Selected Target EAS Declaration Request

Table 8.8.4.17-1 describes information elements for the selected target EAS declaration request sent from the S-EAS to the S-EES.

TABLE 8.8.4.17-1
Selected target EAS declaration request

| Information element | Status | Description |
|---|---|---|
| UE ID | M | The identifier of the UE. |
| Security credentials | M | Security credentials. |
| Selected EAS ID | M | Selected EAS identifier. |
| ACID | O | The identifier of the AC |
| Selected EAS Endpoint | M | Endpoint of the selected EAS. |
| Associated EAS IDs | O | Associated EAS Identifiers, selected by |
| | | the S-EAS. |
| Associated T-EAS | O | A list of associated EAS endpoints in an |
| endpoint list | | EAS bundle, selected by the S-EAS. |
| Predicted/Expected UE | O | The predicted/expected location |
| location or Expected AC | | information of the UE. The UE location is |
| Geographical Service Area | | described in clause 7.3.2 or the |
| | | predicted/expected AC Geographical |
| | | Service Area as described in clause |
| | | 7.3.3.3 |

### 8.15.1 General

EAS information provisioning procedure allows the EEC to exchange information with the EES about selected EAS or ACR scenario selection.

When service continuity is required, service continuity scenarios may be combined to perform ACR detection in one or more of the EEC, the EES and the EAS; the related procedures are specified in clauses 8.15.2, 8.6.3 and referred to in clause 8.8.2. The selection of ACR scenario(s) may be performed by the EEC or the EES for a given AC and the selected EAS from the commonly supported ACR scenarios of AC, EEC, selected EES and selected EAS. The selection of ACR scenario(s) for each EAS in EAS bundles may be performed separately by the EEC or the EES for a given AC and the selected EAS(s) in a bundle, based on the service continuity support by AC, EEC, EES and EAS(s). In addition, the EEC or EES can further determine the one or more ACR scenario(s) for the selected EAS based on the AC service key performance indicator (KPI).

Editor's Note: It is FFS whether the ACR scenario selection for EAS bundles is needed to extend to multiple EES scenario, depending on the feedback from SA5.

NOTE: How to select ACR scenario(s) at the EEC or EES considering AC service KPI is implementation specific.

Information about instantiable EAS may be provided to the EEC as in clause 8.3.3 and 8.5. Triggering the instantiation of an EAS by the EEC may be announced to the EES by including the selected EASID in the EAS information provisioning request without including the selected EAS endpoint.

The EAS information provisioning request types supported are:
“ACR scenario selection announcement”. Inform the EES about the EAS that has been selected by the EEC and may provide the selected ACR scenario list to the EES. For the EAS bundles scenario, the selected bundled EAS(s), the selected main EAS and the selected ACR scenario list for EAS bundles by EEC are included and notified to the EES.
“ACR scenario selection request”. Inform the EES to perform ACR scenario selection. For the EAS bundles scenario, the request may inform the EES to determine the ACR scenario list and the main EAS for EAS bundles.

Any of the features of section 8.15.1 General may be optional.

### 8.15.2.2 EAS Information Provisioning

Pre-conditions:
1. The EEC has performed service provisioning procedure
2. The EEC has performed the EAS discovery procedure

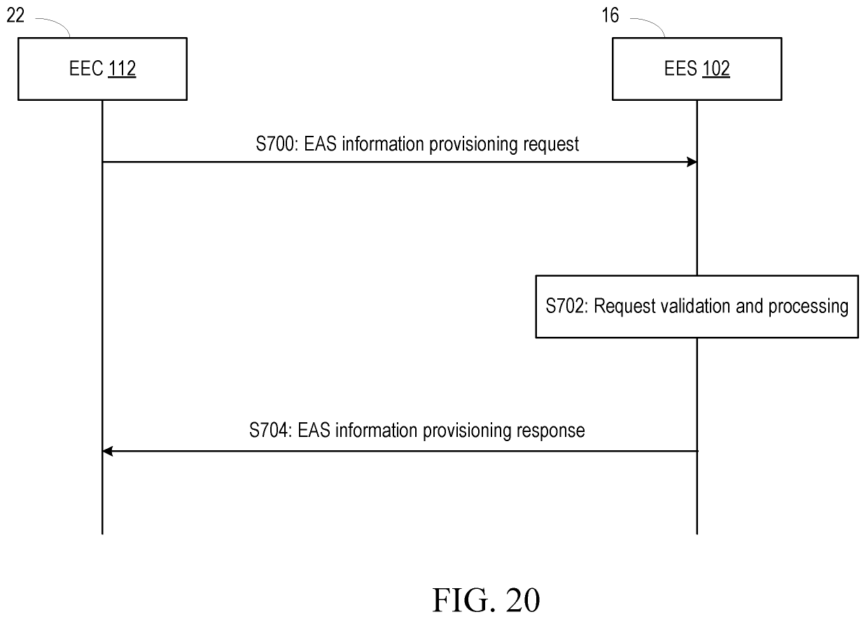

FIG. 20 shows an example of EAS information provisioning. A UE 22 comprising an EEC and a network node (NN) 16 (e.g., EES) are shown.
S700. The EEC sends the EAS information provisioning request to the EES:
   a—“ACR scenario selection announcement”. The request may include ACR scenario list selected by the EEC, EEC security credentials, selected EASID, selected EAS endpoint, EECID and ACID. For the EAS bundles scenario, the request may include the ACR scenario list for EAS bundles selected by the EEC.
   b—“ACR scenario selection request”. The request may include AC profile, EEC service continuity support, EEC security credentials, EECID and ACID.

In some embodiments, the EAS information provisioning request may include associated EES(s) endpoint and the DNAIs and service area of the selected EAS(s).

In some other embodiments, the EAS information provisioning request may include the main EAS of EAS bundle selected by the EEC and the DNAIs and service area of the selected EAS(s).

If the EEC has selected an uninstantiated EAS, the EEC includes the selected EASID without including the selected EAS endpoint in the request.
S702. Upon receiving the request from the EEC, the EES validates the EEC information request and verifies if the EEC is authorized for this operation.
   a—“ACR scenario selection announcement”. The EES may send the ACR Selection notification to the selected EAS if the EAS has subscribed and if EES allows EEC based ACR scenario selection. Otherwise, EES may respond with status failure and include appropriate reason. For the EAS bundles scenario, the EES may send the ACR selection notification to the bundled EAS(s).
   b—“ACR scenario selection request”. The EES selects the ACR scenario list and may send the ACR Selection notification to the selected EAS if the EAS has subscribed. The EES may include the ACR scenario list in the EAS information provisioning response. For the EAS bundles scenario, the EES selects the ACR scenario list for EAS bundles based on the AC/EEC/EES/EAS(s) service continuity support, may select the main EAS and/or may send the ACR scenario list to the bundled EAS(s). In a nonlimiting example, when EES receives “ACR scenario selection request” and EAS bundle without main EAS, this indicates that the EEC requests the EES to select the main EAS in the bundle and the EES is implicitly selected as main EES. Then, the EES performs main EAS selection.

If the EEC or EES selected ACR scenario list for EAS bundle includes EAS executed ACR scenario (as described in 8.8.2.x2), the EES also sends the main EAS indication, DNAIs and service area of the selected EAS(s) to the selected main EAS in the ACR selection notification.

The request may contain the associated EES(s) information along with the bundle EAS information (i.e. list of EASID) and the bundle EAS type indicating direct bundle, each associated EES(s) is along with part of or all the list of EASID, when EEC determines the associated EES(s) based on the EDN configuration information and bundle EAS information (e.g. list of EASID and direct bundle type).

If the request contains selected EAS ID and selected EAS Endpoint, the EES may apply the EAS traffic influence with the N6 routing information of the EAS in the 3GPP Core Network, based on application KPIs and if the EAS traffic influence was not done before (e.g. neither in EAS discovery procedure nor the EAS perform traffic influence).

If the request contains the selected EASID and the selected EAS endpoint is not included, the EES verifies if instantiation of EAS is needed and may trigger the EAS management system to instantiate the EAS as in clause 8.12.

When the request contains EEC Service Continuity Support IE and the EEC context has been established, the EES includes the IE into the EEC context described in Table 8.2.8-1.
NOTE 1: EES can also influence the EAS traffic in advance.
NOTE 2: It is up to the AC to decide when to connect to the selected EAS (either immediately or wait for a while) once the AC knows the selected EAS.
S704. If the processing of the request was successful, the EES sends an EAS information provisioning response to the EEC indicating a successful status. If an EEC context has been established, the response also includes the list of selected ACR scenario(s) into the session context IE within EEC context as described in Table 8.2.8-2; otherwise, the EES may indicate a failure status and include appropriate reasons. If the EES has triggered EAS instantiation based on the EAS information provisioning request and obtained the newly instantiated EAS information, the response contains information about the newly instantiated EAS, including the EAS endpoint information.

The EEC, EES and EAS (or the bundled EAS(s)) use the selected ACR scenario list to determine if they should perform ACR detection and/or ACR decision.

Upon receiving the EAS information provisioning response, if the response includes instantiated EAS information, the EEC uses the endpoint information to subscribe to ACR event notification, as needed, and provides necessary notifications to the AC.
NOTE 3: Other ACR selection criteria are out of scope of the current specification.
NOTE 4: The commonly supported ACR scenarios are decided as part of the EAS discovery and selection procedure.

Steps S700, S702, and S704 may be referred to as steps 1, 2, and 3, respectively.

### 8.15.3.2 (Option 1) EAS Information Provisioning Request

Table 8.15.3.2-1 describes the information elements for EAS information provisioning request from the EEC to the EES.

TABLE 8.15.3.2-1
EAS information provisioning request

| Information element | Status | Description |
|---|---|---|
| EECID | M | The identifier of the EEC. |
| ACID | M | The identifier of the AC. |
| Security credentials | M | Security credentials resulting from a |
| | | successful authorization for the edge |
| | | computing service. |
| Selected EAS ID(s) | O | The identifier(s) of the selected EAS or |
| | | the selected EAS(s) for EAS bundles, |
| | | which is either instantiated or instantiable. |
| Selected EAS Endpoint(s) | O | The endpoint(s) of the selected EAS or the |
| | | selected EAS(s) for EAS bundles |
| DNAIs and service area of the | O | For each selected EAS ID, it includes the |
| selected EAS(s) | | DNAIs and/or service area for EAS |
| | | bundles, as described in ‘EAS |
| | | Geographical Service Area’ IE, ‘EAS |
| | | Topological Service Area’ IE and ‘List of |
| | | EAS DNAI(s)’ IE of Table 8.2.4-1. |
| Associated EES(s) endpoint | O | EES information which support all or part |
| | | of the direct bundled EAS within the same |
| | | DNAI associated with the part of EASID |
| | | list. |
| Request type | O | Request types: |
| | | ACR scenario selection announcement |
| | | ACR scenario selection request |
| Selected ACR scenario list | O | The list of ACR scenarios (or the list of |
| (see NOTE 1) | | ACR scenarios for EAS bundles) selected |
| | | by the EEC |
| AC Profile (see NOTE 2, | O | AC Profile as described in Table 8.2.2-1 |
| NOTE 3) | | |
| EEC Service Continuity | O | Indicates if the EEC supports service |
| Support (NOTE 2) | | continuity or not. The IE indicates which |
| | | ACR scenarios are supported by the EEC, |
| | | also indicates the EEC ability of handling |
| | | bundled EAS ACR. |

(NOTE 1):
The IE may be present only if Selected EASID(s) and Selected EAS Endpoint(s) are present and Request type is “ACR scenario selection announcement”.
(NOTE 2):
The IEs are present only if request type is “ACR scenario selection request”.
(NOTE 3):
The IE is present if AC Profile is not shared to EES previously.

### 8.15.3.2 (Option 2) EAS Information Provisioning Request

Table 8.15.3.2-1 describes the information elements for EAS information provisioning request from the EEC to the EES.

TABLE 8.15.3.2-1
EAS information provisioning request

| Information element | Status | Description |
|---|---|---|
| EECID | M | The identifier of the EEC. |
| ACID | M | The identifier of the AC. |
| Security credentials | M | Security credentials resulting from a |
| | | successful authorization for the edge |
| | | computing service. |
| Selected EAS ID(s) | O | The identifier(s) of the selected EAS or |
| | | the selected EAS(s) for EAS bundles, |
| | | which is either instantiated or instantiable. |
| Selected EAS Endpoint(s) | O | The endpoint(s) of the selected EAS or the |
| | | selected EAS(s) for EAS bundles |
| Selected main EAS ID and | O | The selected main EAS ID and endpoint |
| Endpoint | | for EAS bundle. |
| DNAIs and service area of the | O | For each selected EAS ID, it includes the |
| selected EAS(s) (or selected | | DNAIs and/or service area for EAS |
| EDN(s)). | | bundles, as described in ‘EAS |
| | | Geographical Service Area’ IE, ‘EAS |
| | | Topological Service Area’ IE and ‘List of |
| | | EAS DNAI(s)’ IE of Table 8.2.4-1. |
| Request type | O | Request types: |
| | | ACR scenario selection announcement |
| | | ACR scenario selection request |
| Selected ACR scenario list | O | The list of ACR scenarios (or the list of |
| (see NOTE 1) | | ACR scenarios for EAS bundles) selected |
| | | by the EEC |
| AC Profile (see NOTE 2, | O | AC Profile as described in Table 8.2.2-1 |
| NOTE 3) | | |
| EEC Service Continuity | O | Indicates if the EEC supports service |
| Support (NOTE 2) | | continuity or not. The IE indicates which |
| | | ACR scenarios are supported by the EEC, |
| | | also indicates the EEC ability of handling |
| | | bundled EAS ACR. |

(NOTE 1):
The IE may be present only if Selected EASID(s) and Selected EAS Endpoint(s) are present and Request type is “ACR scenario selection announcement”.
(NOTE 2):
The IEs are present only if request type is “ACR scenario selection request”.
(NOTE 3):
The IE is present if AC Profile is not shared to EES previously.
****** alternative of main EAS determination *******

### 7.2.10 EAS Bundle Information

The EAS bundle information can be a list of EASIDs or a bundle ID, EAS bundle requirements. The EAS bundle information also includes main EASID. EAS bundle ID establishes an association between the EASs. When included in the EAS profile, EAS bundle ID denotes the bundle to which the EAS belongs. When included in the AC profile EAS bundle ID is used to perform different Edge Enabler Layer operations, such as EAS discovery. Edge Enabler Layer handles the EASs belonging to the same bundle as required by related EAS bundle requirements as described in clause 8.2.x.
NOTE 1: Both, EAS bundle ID and EAS bundle requirements, are provided by the ASP.
NOTE 2: Bundle ID is necessary when the affinity between bundled EASs is strong or exceeds or is equal to a predetermined threshold (e.g., co-deployment and co-migration is essential), and the related ASPs which provide the AC and bundled EASs established the bundle. List of EASIDs is required when the affinity between the bundled EASs is weak is less than the predetermined threshold (e.g., co-deployment and co-migration is only “nice to have”).

### 8.2.2 AC Profile

An AC Profile includes information about AC used to determine services and service characteristics required.

TABLE 8.2.2-1
AC Profile

| Information element | Status | Description |
|---|---|---|
| ACID | M | Identity of the AC. |
| AC Type | O | The category or type of AC (e.g., V2X). |
| | | This is an implementation specific value. |
| Preferred ECSP list | O | When used in a service provisioning |
| | | request, this IE indicates to the ECS |
| | | which ECSPs are preferred for the AC. |
| | | The ECS may use this information in the |
| | | selection of EESs. |
| AC Schedule | O | The expected operation schedule of the |
| | | AC (e.g., time windows) |
| Expected AC Geographical | O | The expected location(s) (e.g., route) of |
| Service Area | | the hosting UE during the AC's operation |
| | | schedule. This geographic information can |
| | | express a geographic point, polygon, |
| | | route, signalling map, or waypoint set. |
| AC Service Continuity | O | Indicates if service continuity support is |
| Support | | required or not for the application. The IE |
| | | indicates which ACR scenarios are |
| | | supported by the AC and which of these |
| | | are preferred by the AC, also indicates the |
| | | AC ability of handling bundled EAS |
| | | ACR. |
| Simultaneous EAS | O | Indicates if simultaneous EAS |
| connectivity information in | | connectivity is needed and the inactive |
| service continuity | | time guidance for keeping connectivity |
| | | towards the S-EAS. |
| List of EASs | O | List of EAS that serve the AC along with |
| | | the service KPIs required by the AC |
| >EASID | M | Identifier of the EAS |
| >Expected AC Service | O | KPIs expected in order for ACs to receive |
| KPIs | | currently required services from the EAS, |
| | | as described in Table 8.2.3-1 |
| >Minimum required AC | O | Minimum KPIs required in order for ACs |
| Service KPIs | | to receive meaningful services from the |
| | | EAS, as described in Table 8.2.3-1 |
| List of required EAS | O | Information related to the EAS bundles |
| bundle information | | which AC requires. |
| >Bundle ID or list of | M | A list of EASIDs or a bundle ID as |
| EASID | | described in clause 7.2.10. |
| >Main EASID | M | Indicate which EAS in a bundle takes the |
| | | main EAS service role. |
| >EAS bundle | O | Requirements associated with the EAS |
| requirements | | bundle as described in clause 8.2.10. |

TABLE 8.2.4-1
EAS Profile

| Information | | |
|---|---|---|
| element | Status | Description |
| EASID | M | The identifier of the EAS |
| EAS Endpoint | M | Endpoint information (e.g., URI, FQDN, IP address) used |
| | | to communicate with the EAS. This information maybe |
| | | discovered by EEC and exposed to ACs so that ACs can |
| | | establish contact with the EAS. |
| List of EAS | O | List of EAS bundles to which the EAS belongs and |
| bundle | | related bundling requirements. |
| information | | |
| >Bundle ID | M | Bundle ID as described in clause 7.2.10. |
| >Main EASID | M | Indicate which EAS in a bundle takes the main EAS |
| | | service role. |
| ACID(s) | O | Identifies the AC(s) that can be served by the EAS |
| EAS Provider | O | The identifier of the ASP that provides the EAS. |
| Identifier | | |
| Allowed MNO | O | Information of the allowed operator (e.g., MNO name, |
| information | | PLMN ID) from which its subscriber can consume the |
| | | EAS services |
| EAS Type | O | The category or type of EAS (e.g., V2X) |
| EAS description | O | Human-readable description of the EAS |
| EAS Schedule | O | The availability schedule of the EAS (e.g., time windows) |
| EAS | O | The geographical service area that the EAS serves. ACs in |
| Geographical | | UEs that are located outside that area may not be served. |
| Service Area | | |
| EAS Topological | O | The EAS serves UEs that are connected to the Core |
| Service Area | | Network from one of the cells included in this service |
| | | area. ACs in UEs that are located outside this area may |
| | | not be served. See possible formats in Table 8.2.7-1. |
| EAS Service | O | Service characteristics provided by EAS, detailed in |
| KPIs | | Table 8.2.5-1 |
| EAS service | O | Level of service permissions e.g., trial, gold-class |
| permission level | | supported by the EAS |
| EAS Feature(s) | O | Service features e.g., single vs. multi-player gaming |
| | | service supported by the EAS |
| EAS Service | O | Indicates if the EAS supports service continuity or not. |
| continuity support | | This IE indicates which ACR scenarios are supported by |
| | | the EAS, also indicates the EAS ability of handling |
| | | bundled EAS ACR. |
| EAS Transport | O | This IE indicates the EAS service continuity support for |
| layer service | | seamless transport layer (e.g., TCP/TLS/QUIC) relocation |
| continuity support | | |
| General context | O | The time duration that the EAS holds the context before |
| holding time | | the AC connects to the EAS in case of ACR for service |
| duration (NOTE) | | continuity planning. It is an indication of the time the EAS |
| | | holds the application context for a UE to move to its |
| | | service area after receiving an ACR notification from the |
| | | EES following an ACR request from the EEC. |
| List of EAS | O | DNAI(s) associated with the EAS. This IE is used as |
| DNAI(s) | | Potential Locations of Applications in clause 5.6.7 of |
| | | 3GPP TS 23.501. |
| | | It is a subset of the DNAI(s) associated with the EDN |
| | | where the EAS resides. |
| List of N6 Traffic | O | The N6 traffic routing information and/or routing profile |
| Routing | | ID corresponding to each EAS DNAI. |
| requirements | | |
| EAS Availability | O | The availability reporting period (i.e., heartbeat period) |
| Reporting Period | | that indicates to the EES how often it needs to check the |
| | | EAS's availability after a successful registration. |
| EAS Status | O | The status of the EAS (e.g., enabled, disabled, etc.) |

(NOTE):
Since the EASID of the EAS identifies the type of the application (e.g., SA6Video, SA6Game etc) as described in clause 7.2.4, “General context holding time duration” determined by EAS can depend on the EASID (type of the application).
Editor's Note:
Whether EAS bundle requirement is needed in EAS profile or EAS discovery filters is FFS.
(NOTE):
The EAS Transport layer service continuity support can be used in EAS discovery, e.g. as described in 3GPP TS 23.433 for SEALDD server acting as EAS, which can further support the EAS IP replacement function.

### 8.2.10 EAS Bundle Requirements

The following IEs describe the EAS bundle requirements:

TABLE 8.2.10-1
EAS bundle requirements

| Information | | |
|---|---|---|
| element | Status | Description |
| Coordinated EAS | O | Indicates if coordinated EAS discovery is required i.e., if |
| discovery | | EAS discovery request for one of the bundled EAS is |
| | | processed, then EAS discovery response should include |
| | | information of all the EASs belonging to the bundle. |
| Coordinated ACR | O | Indicates if coordinated ACR is required i.e., if EAS ACR |
| | | is initiated for one of the bundled EAS, then ACR should |
| | | be initiated for all the EASs belonging to the bundle. |
| | | The IE may further indicate what actions must be taken if |
| | | ACR for one or more bundled EAS fails e.g. ACR for all |
| | | other EAS that are part of the bundle must be cancelled or |
| | | not. |
| Affinity | O | Indicates the affinity requirement of the EAS bundle. The |
| | | IE can be set to ‘strong’ indicating that the EASs must be |
| | | in the same EDN, ‘preferred’ indicating that it is nice to |
| | | have EASs in the same EDN but not essential or ‘weak’ |
| | | indicating that it is not essential for EASs to be in the |
| | | same EDN. |

In some embodiments, the related EAS classes may or may not have similar KPIs and requirements (e.g., as described in 3GPP meeting, S6-230509). In general, the following may be performed: declare dependencies between classes of EAS when provisioning them for any deployment scenario; indicate whether the affinity between them is strong (e.g., co-deployment and co-migration is essential) or weak (e.g., co-deployment and co-migration is only “nice to have”). The system could then use this knowledge, alongside the KPI requirements of each EAS class, to determine the most optimal placement of EAS instances across the hosting estate at any given instant.

Further, Bundle ID may be necessary when the affinity between bundled EASs is strong (e.g., co-deployment and co-migration is essential), and the related ASPs which provide the AC and bundled EASs established the bundle (e.g., as described in 3GPP TS 23.558 V18.2.0 (2023-03) description, clause 7.2.10). List of EASIDs may be required when the affinity between the bundled EASs is weak (e.g., co-deployment and co-migration is only “nice to have”).

In some other embodiments, during deployment, if EAS affinity is set to strong, associated EASs are preferably to be registered in the same EES; otherwise, associated EASs can register in the same EES in an EDN or different EESs in the same EDN or different EDNs.

In some embodiments, the main S-EAS or main S-EES may be enabled to know the service area and DNAIs of the associated S-EASs so it can make ACR decision based on detected information (e.g., UE location change, DNAI change). The information of “service area & DNAIs of associated EASs in a bundle” may be used because the main server is to make ACR decision for its associated EASs in a bundle. In some examples, it is not needed to relocate EASs. It is possible that some EASs in a bundle do not need relocation because the UE can still be served by these EASs. A deployment example is both EASs providing services covering the whole city and EASs providing services covering city district are serving the AC as an EAS bundle, and when UE moves from one district to another district in the city, only EASs serving the district from where UE is moving out need relocation.

In some other embodiments, the main server determination procedure for a bundle is described where a pre-condition may be one or both of:
1. The EEC has performed service provisioning procedure; and
2. The EEC has performed the EAS discovery procedure.

In some embodiments, the EEC performs EAS discovery, so it knows the service area and/or DNAI of EASs in a bundle. The EEC can provide this information to EES (e.g. via EAS information provisioning) and then from EES to selected main EAS. In some other embodiments, in the EAS composition case, the EEC only knows only one connecting EAS for the AC. So, the connecting EAS is the main EAS, and this is a special case in EEC side determination for main EAS.

The following is a list of nonlimiting example embodiments.
1. A network node (16), the network node (16) being configured to, and/or comprising a radio interface (62) and/or comprising processing circuitry (68) configured to:
determine a single entity associated with an application context relocation, ACR, process, the single entity being an edge application server, EAS, the single entity being provided with information about a service area and a Data Network Access Identifier, DNAI, of at least one associated EAS, the information being usable to make an ACR decision based on detected information.
2. A method implemented in a network node (16), the method comprising:
determining (S134) a single entity associated with an application context relocation, ACR, process, the single entity being an edge application server, EAS, the single entity being provided with information about a service area and a Data Network Access Identifier, DNAI, of at least one associated EAS, the information being usable to make an ACR decision based on detected information.
3. A user equipment, UE (22), the UE (22) being configured to, and/or comprising an edge enabler client, ECC, a radio interface (82) and/or processing circuitry (84) configured to:
determine a first single entity associated with an application context relocation, ACR, process, the first single entity being an edge application server, EAS, the first single entity being provided with information about a first service area and a first Data Network Access Identifier, DNAI, of at least one associated EAS, the information being usable to make a first ACR decision based on first detected information.
4. The UE (22) of Example 3, wherein the EEC is configured to:
determine a second single entity, the second single entity being an edge enabler server, EES, the second single entity being provided with information about a second service area and a second DNAI of at least one associated EAS, the information being usable to make a second ACR decision based on second detected information.
5. A method implemented in a user equipment, UE, (22), comprising an edge enabler client, ECC, the method comprising:
determining (S136) a first single entity associated with an application context relocation, ACR, process, the first single entity being an edge application server, EAS, the first single entity being provided with information about a first service area and a first Data Network Access Identifier, DNAI, of at least one associated EAS, the information being usable to make a first ACR decision based on first detected information.
6. The method of Example 5, wherein the method further comprises:
determining, by the ECC, a second single entity, the second single entity being an edge enabler server, EES, the second single entity being provided with information about a second service area and a second DNAI of at least one associated EAS, the information being usable to make a second ACR decision based on second detected information.
7. A network node (16) configured to communicate with a user equipment, UE (22), the UE (22) comprising an edge enabler client, EEC, the network node (16) configured to, and/or comprising a radio interface (62) and/or comprising processing circuitry (68) configured to:
determine and transmit to the EEC edge data network, EDN, connection information associated with an application context relocation, ACR, process, the EDN connection information comprising information usable by the EEC to determine what data network name, DNN, and source network slice selection assistance information, S-NSSAI, are to be used to establish a protocol data unit, PDU, session for application traffic towards a target EDN.
8. A method implemented in a network node (16) configured to communicate with a user equipment, UE (22), the UE (22) comprising an edge enabler client, EEC, the method comprising:
determining (S138) and transmitting to the EEC edge data network, EDN, connection information associated with an application context relocation, ACR, process, the EDN connection information comprising information usable by the EEC to determine what data network name, DNN, and source network slice selection assistance information, S-NSSAI, are to be used to establish a protocol data unit, PDU, session for application traffic towards a target EDN.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a first network node comprising a first edge application server, EAS, the method comprising:
determining, based on one or both of a service area and a data network access identifier, DNAI, of all EASs in bundled EASs, that an application context relocation, ACR, is to be performed in a bundle for the bundled EASs, each EAS of the bundled EASs having at least one session with an application client, AC, in a user equipment, UE;
discovering target EASs in the bundle for the bundled EASs, the target EASs being within a same edge data network, EDN, or different EDNs based on an EAS affinity; and
transmitting to an edge enabling server, EES, a declaration message comprising one or more identifiers and endpoints of selected target EASs in the bundle for causing initiation of an application context transfer, ACT, procedure between the EASs in the bundled EASs and the selected target EASs in the bundle.

2. The method of claim 1, wherein the method further includes:
determining the one or both of the service area and the DNAI of all EASs in the bundled EASs based on one or more parameters.

3. The method of claim 1, wherein at least two target EASs are within the same EDN when the EAS affinity exceeds or is equal to a predetermined EAS affinity threshold, and the at least two target EASs are within different EDNs when the EAS affinity is less than the predetermined EAS affinity threshold.

4. The method of claim 1, wherein the declaration message triggers the EES to send selected target EASs to an edge enabler client, EEC, of the UE.

5. The method of claim 1, wherein one or both of:
the method further includes transmitting a declaration request to the EES, the declaration request including one or more of a bundle identifier, ID, a list of EAS IDs, and EAS endpoint list; and
the declaration request is comprised in the declaration message.

6. The method of claim 1, wherein the EAS is a main EAS, and the EES is a main EES.

7. (canceled)

8. A method implemented in a user equipment, UE, the UE comprising an edge enabler client, ECC, the method comprising:
determining that an application context relocation, ACR, is to be performed in a bundle for bundled edge application servers, EASs, each EAS of the bundled EASs having at least one session with an application client, AC in the UE;
discovering target EASs in the bundle for the bundled EASs, the target EASs being within same edge data network, EDN, or different EDNs based on an EAS affinity; and
transmitting to an edge enabling server, EES, an ACR request comprising at least one of one or more identifiers and endpoints of selected target EASs in the bundle.

9. The method of claim 8, wherein the ACR request comprises endpoint information of at least one target EAS of a previous ACR.

10. The method of claim 9, wherein the endpoint information comprises one or more of a unified resource identifier, URI, a fully qualified domain name, FQDN, and an internet protocol, IP, 3-tuple.

11. The method of claim 9, wherein the ACR request further includes endpoint information of at least one target EAS of a previous ACR when the EEC resends the ACR request to indicate the previous ACR is to be cancelled.

12. The method of claim 8, wherein the ACR request further includes a list of associated EAS endpoints in the bundle.

13. The method of claim 8, wherein the method further includes:
subscribing to receive ACR information notifications for target information notification events and ACR complete events from EESs serving the bundle.

14. (canceled)

15. A method implemented in a second network node comprising an edge enabling server, EES, the method comprising:
determining, based on one or both of a service area and a data network access identifier, DNAI, of all edge application servers, EASs, in bundled EASs, that an application context relocation, ACR, is to be performed in a bundle for the bundled EASs, each EAS of the bundled EASs having at least one session with an application client, AC, in a user equipment, UE;
discovering target EASs in the bundle for the bundled EASs, the target EASs being within same edge data network, EDN, or different EDNs based on an EAS affinity; and
one of:
transmitting to an edge enabling client, EEC, in the UE a notification message comprising one or more identifiers and endpoints of selected target EASs in the bundle and initiating, and triggering initiation of an application context transfer, ACT, procedure between the EASs in the bundled EASs and the selected target EASs in the bundle; and
transmitting to the EEC in the UE and to a source EAS, S-EAS, behaving as a main S-EAS for the bundled EASs the one or more identifiers and endpoints of the selected target EASs in the bundle and initiating, and triggering initiation of the ACT procedure between the EASs in the bundled EASs and the selected target EASs in the bundle.

16. The method of claim 15, wherein the method further comprises:
transmitting to at least one of the EAS in the bundled EAS at least one of the identifiers and endpoints of the selected target EASs.

17. The method of claim 15, wherein the method further includes:
triggering application traffic influence for the selected target EASs.

18. The method of claim 15, wherein the method further includes:
notifying a main S-EAS of the selected target EASs of the same EAS service.

19. The method of claim 15, wherein the method further includes:
performing an ACR launching procedure including an ACR action indicating ACR initiation and corresponding ACR initiation data to associated EESs.

20. The method of claim 19, wherein the ACR action triggers the associated EESs to notify corresponding bundled source EAS, the ACT starting between the source EAS and the target EASs in the bundle requiring service continuity.

21. (canceled)

22. The method of claim 2, wherein at least two target EASs are within the same EDN when the EAS affinity exceeds or is equal to a predetermined EAS affinity threshold, and the at least two target EASs are within different EDNs when the EAS affinity is less than the predetermined EAS affinity threshold.

23. The method of claim 2, wherein the declaration message triggers the EES to send selected target EASs to an edge enabler client, EEC, of the UE.
